(19) United States
(12) Patent Application Publication
(10) Pub. No.: US 2013/0314421 A1
(43) Pub. Date: Nov. 28, 2013

(54) LECTURE METHOD AND DEVICE IN VIRTUAL LECTURE ROOM

(71) Applicant: Young Dae Kim, Seoul (KR)

(72) Inventor: Young Dae Kim, Seoul (KR)

(21) Appl. No.: 13/980,631

(22) PCT Filed: Feb. 14, 2012
(86) PCT No.: PCT/KR12/01117

§ 371 Date: Jul. 19, 2013

(30) Foreign Application Priority Data
Feb. 14, 2011 (KR) 10-2011-0012853

(51) Int. Cl. G06T 19/00

(52) U.S. Cl. CPC G06T 19/006
USPC 345/427

(57) ABSTRACT

Disclosed in a lecture method in which a presentation content of various inputs (cameras, notebook computer, motion pictures) is combined with a virtual lecture room using a Chromakey or TOF technique, so displaying a lecture and a presentation content on one screen with a beautiful background studio screen. The lecture method of the present invention comprises (1) a virtual lecture room editing and storing step in which a plurality of 3D background layers are provided, edited and designed, the lecturer and the presentation content are arranged in the virtual lecture room and are displayed on various screens, (2) a step in which the image of the lecture of the lecturer is taken using a single or a plurality of cameras, (3) a step in which the image of only a lecturer is extracted from the taken lecture images using a Chromakey technique in a form of a lecturer layer, (4) a step in which a lecture material layer and the lecturer layer are combined with the virtual lecture room graphic background layer, with the lecture material layer indicating at least one lecture material, and (5) a step in which the final image is combined and outputted to the display apparatus when the lecturer writes using the tablet.

### CROSS REFERENCE RELATED APPLICATION

This application claims foreign priority of Korean Patent Application No. 10-2011-0012853, filed on Feb. 14, 2011, which is incorporated by reference in its entirety into this application.

The present invention relates to a virtual classroom lecture method and a system using the same which are characterized in that a lecturer image is extracted using a Chromakey technique or the like, and the extracted image is combined with a graphic background along with a presentation material (notebook computer screen, etc), and in particular to a system for a real time automatic virtual lecture implemented in such a way that as a way of eliminating background, a Chromakey technique is used or a technique for comparing the images of background is used assuming that there is a lecturer or not or a technique of extracting only a video from at a distance of a standing lecturer by using a time of flight sensor can be used. The image of a lecturer the background of which is eliminated and a lecture material screen (PPT or notebook computer screen) are combined with a 2D or 3D graphic background. The program can be automatically operated with a mouse click or can be operated with a simple button control. Various combined scenes are converted in real time and are recombined and outputted, which helps audience see a desired scene, namely, a presentation material in an enlarged size, and a screen switch can be automatically performed by a lecturer, so audience can concentrate on the content of a lecture while looking at in one direction a beautiful graphic virtual classroom, thus helping audiences concentrate on the content of a lecture.

### BACKGROUND ART

In recent years, various seeing and hearing apparatuses have been used in order to provide a presentation more effectively. The presentation apparatus generally used at an advanced lecture classroom such as a multimedia classroom or the like is formed of an electronic lecture desk, an electronic blackboard, and an image reading apparatus. The notebook computer is generally used for a projector.

Limits in Lecture Classroom Decorations

In a conventional lecture method, as a lecture is generally performed in a lecture classroom equipped with a fixed projector screen or in a seminar room. The lectures are always provided in the same place. So, it is impossible to create an environment of lecture like an advanced studio well matching with an exclusive environment that audience generally prefers. When recording a lecturer in such classroom, the good content of a lecture might not be created, and the effects of lecture cannot be maximized. In order to improve the above problems, creating a special studio-like lecture classroom for every lecture as in a broadcasting station studio costs a lot, practically speaking it is impossible. The present invention is basically directed to creating a scene of a virtual lecture room on a projector screen. A beautiful virtual studio-like lecture classroom is created on a screen at which more audience's eyes can be focused. It is possible to provide a lecture under the best lecture environment as that in a broadcasting station studio.

Problems that Audience Cannot Decide where to Watch Either Screen or Lecturer

When using the above projector, a motion picture or the like can be displayed on a screen. The effects of lecture can be maximized using a presentation program such as a power point program. The present to invention can be used as a necessary item for presentation. An electronic blackboard function is further provided, which helps a user to draw and write down on a screen of a projector. In the above conventional system, audience should look at alternatively either a lecturer or a screen with lecturing materials because the audience is needed to concurrently look at two spaced-apart objects, which cause the quality of lecture to go down.

For a conference or a large size lecture classroom where uses a large size projector, audience tend to see more the screen without looking at a lecturer's figure, face or gesture, so the quality of lecture is lowered. In particular, without a lecturer using a pointer, the audience might focus on less intensively. In the event that a lecturer uses a pointer, when a lecturer turns off the pointer, the audiences' eyes cannot quickly return to the lecturer's face on their own. In this case, the audience loses his concentration while judging where to look at.

Problems in recording real time lecture when a projector is used.

In addition, recording a lecture in real time using the above apparatus makes a complicated procedure because it is needed to use broadcasting equipment for a combination of two screens. The above system is almost impossible for a common lecture. Most of the equipment developed for a remote lecture is not actually applied because of the difficulties in terms of recording and editing procedures. In particular, for the real time lecture recording, it is needed to select a scene depending on an operator's or lecturer's intention. So, recording a lecture in real time is almost impossible unless a lecturer handles equipment in person. A video motion picture or a remote real time lecture produced by a conventional system does not feel like an actual lecture, so the lectures performed all over the world are not recorded actually, and even when the lectures are recorded, a recorded video tape lecture is failing to substitute actual lectures, and a remote lecture is not actually applied. The presentation lecture recording is not actually performed for now. The remote presentation conference is not actually performed for now as well. The video tapes are needed to transferred to somewhere for a conference, and it is needed to transmit two scenes of a lecturer and a presentation screen using special equipment which results in a poor lecture effect in an application-limited remote conference/lecture system.

Apparatus of Lecture Video Output and Real Time Lecture Recording and Remote Lecture which are Better than Actual Lecture

The present invention is made to improve the above mentioned problems and provides a new lecture system. The system of the present invention is characterized in that a lecturer and a presentation material are freely sized on a screen of a projector, thus producing a good-looking virtual lecture in graphics. The audience can concentrate on the content of a lecture in such a way that the audience looks at an advanced screen and a lecturer's screen as compared with the conventional art in which the audience looks at one scene. The lecture can be automatically performed while the lecturer gives a lecture. The recorded video according to the present invention provides a stronger lecture effect as compared with a lecture video recorded in the conventional art and an actual lecture. The lecture video can be produced, which have the quality above the video made in the actual broadcasting studio, so it does not need to record once the lecture is made. In the event that the lecture is provided by way of the network to a remote place, the audience positioned in the remote place can feel like more than the actual lecture, thus helping the audience to focus more intensively.

Automatic Presentation Apparatus in which the Scenes are Automatically Switched while a Lecturer is Giving a Lecture

During the real time lecture, the lecturer cannot consult with an apparatus operator for selecting scenes or content to be displayed, while he is giving a lecture. Since the lecturer cannot handle equipment while he is giving a lecture, all the operations needed during the lecture are automated without the lecturer caring of the operations of the equipment. When it is needed for a lecturer to do something, one touch button method is preferred, thus intuitively handling the equipment. The present invention is directed to an apparatus which produces various output scenes which are automatically combined in real time as the beautiful graphic backgrounds are provided on one screen combined with a lecturer and presentation materials by way of a mouse operation in real time. In the present invention, it is possible to produce various scenes on one screen with a lecturer and presentation materials at a lecture classroom, an office, a seminar room or a conference room while an expert does not handle in the studio a complicated switch mixer, a camera, VTR, an image reading apparatus, a notebook computer or the like which are generally used in the advanced lecture recording system. When the lecturer selects a major portion of the presentation content and points with a mouse pointer, various output scenes are shown in combination with the virtual lecture classroom like lecturing at the broadcast studio while the exclusive camera man and the broadcasting experts are handling advanced cameras. So, the present invention can help the audience to have an intensive concentration, and the optimized lecture contents in an easier way. The lecturer and the presentation content are automatically combined and sized for the best scenes. The lecture can be displayed in various scenes in the form of beautiful virtual images so as to help the audience to have intensive concentration like the actual broadcasts performed in the exclusive studio, and the virtual cameras are automatically switched, and the lecturer focus at the content of the lecture like a plurality of camera men take pictures to produce a plurality of virtual scenes while moving around, thus actually producing the lecture scenes like the broadcast scenes.

Intensive Virtual Lecture System with the Aid of 3D Stereo Graphic Outputs

The above-mentioned combined video screens are produced by means of left and right virtual cameras (or one camera) and are switched in a 3D with the left and right scenes being divided at 50:50 in the input and output format (for example, 120 Hz output method with 60 Hz assigned to left side, 60 Hz assigned to right side). The screen is divided into upper, lower, left and right sides, thus forming a 3D lecture scene by means of which a virtual reality situation is made in an effective way.

### DISCLOSURE OF THE INVENTION

Accordingly, the present invention is made to overcome or improve the above descried problems encountered in the conventional art and it is an object of the present invention to provide a virtual classroom lecture method and a system using the same which are characterized in that the present invention is basically directed to overcome the limits of the lecture classroom that the lecture effects are lowered, and it is impossible to make the scenes of good-looking studios needed for the lecture records and internet broadcast since the above limits lie in that the scenes of the lecturer and the representation materials are shown together at the lecture place like a modern type presentation lecture room, a seminar room, a conference room, and a hotel lecture room where it uses various hearing and seeing equipment including a projector screen. The conventional problems related to the present invention will be described in more details as follows.

(1) There are limits in switching the lecture classroom in the conventional art so as to enhance the lecturer's or audience's lecture concentration in such a way to make the interior of the lecture classroom look like the studio room in the broadcast station (it is possible to maximize the effects of the lecture looking like the excellent studio without changing the lecture classroom with the aid of the virtual graphic combination).

(2) As the presentation is changed from using the blackboard at a classroom or a conference room to the presentation using a projector the presentation begins to use various apparatuses such as a power point, a notebook computer, an electronic lecture desk, an electronic blackboard and an image reading apparatus (document camera), and various complicated cables and operations are needed to connect the apparatuses, which leads to lowering the lecture's teaching concentrations. So, it is needed to integrate all the above complicated apparatus into one system with one touch method.

(3) When using the equipment for a lecture record and a remote lecture, special equipment and experts are needed, and since a real time cooperation between lecturers is not expected in the conventional art, an effective lecture is impossible. It is necessary for the equipment needed for a lecture record and a remote lecture to be integrated into one system with one touch method and all the equipment are needed to operate by the lecturer in an intuitive way.

(4) In terms of most of the lecture methods which show the visual representation materials such as a projector or the like, it is needed for the audience to look at one part between two parts of the lecturer and the representation screen as compared to the conventional blackboard lecture. As the audiences are needed to look at the same scenes at the fixed place, the lecture loses concentrations, so it is impossible to enhance the concentration of the lecture by way of the screen change and control with the aid of camera switching and zooming using plurality of cameras at every 5 to 20 seconds as in the broadcast station.

(5) Since the lectures and the field of view (FOV) of the screen seen from the audience sitting at the front line of the lecture classroom and that from the audience sitting at the rear line of the same look different, there is a big difference in terms of the concentrations of the audiences due to different places in one classroom.

In addition, there is a problem in a special broadcast equipment and an editing technique when recording the lecture in one video and transmitting the recorded video or in terms of a remote lecture or a conference, so a real time lecture record or a presentation remote lecture and a conference are not efficiently performed. In the present invention, a lecturer and a projector screen are efficiently mixed in real time, and a certain scene in terms of an output of a video can be created automatically or in a simple manual way along with a scene control and transmission function.

(7) For the presentation using a blackboard, during the presentation, the audience's attentions are naturally focused on the presenter, and for the presentation using the projector, as shown in FIG. 1, the audience's attentions are divided into the presenter and the presentation content. The determination of the target of the attention is up to the audience. When the audience determines the opposite content when an important content is presented, namely, when it is needed to focus on the material, the audience might look at the presenter, and when it is needed to focus on the presenter, the audience might look at the content.

So, the necessary and important content might not be transmitted from the presenter to the audience while losing the concentration of the lecture. As a proper way to overcome the above problem, it is urgently needed to develop a new automatic scene mixing method.

(8) The presentation using the projector makes it possible to easily provide a seeing and hearing education along with various presentation software and photos and motion pictures on the screen as compared to the conventional blackboard-based method while improving the problems occurred when using only the blackboard. The presentation can be made possible as it uses a large size screen at a large size lecture classroom which leads to a large size classroom trend, so the large size conference can be held. Since only the screen is increased without the size of the presenter being increased, the presenter's emotion or expression is not effectively transferred. As the lecture classroom becomes larger, the presentation might have only screen and audio. As shown in FIG. 2, since the presenter looks much smaller than the size of the screen, the audience's attentions might be focused on only the screen, so there is not an eye contact between the presenter and the audience. Since the audiences listen to only the voice of the presenter, the lecture becomes boring.

(9) There is a way of moving the audience's attention to the content of the screen using a tool such as a laser pointer, but it is impossible to change the audience's attention from the content to the presenter, in other words, the audience's attention is not changed to the presenter as the audience keeps looking at the content.

(10) Since the lecture classroom becomes large using the projector, as shown in FIG. 3, the audience sitting far from the presenter cannot see clearly the presenter's face and expression and gesture, which results is non-efficient lecture.

(11) As shown in FIG. 4, for the case showing the lecture on a separate screen by providing two screens, the lecturer and the content are separated, so the audience's attention loses, and when showing by switching to one side, it is needed for the operator to know the lecturer's intention. In this case, the lecturer cannot use the equipment in person. The above equipment might not be used at a large size center such as a hotel or the like, so only the size of the screen is enlarged. As described above, in this case the audiences cannot recognize the lecturer during the seminar.

(12) As shown in FIG. 5, the method of using two screens for the content and the presenter is applied at a remote conference; however it is needed to equip with a complicated and special system so as to separately transmit two video screens and display the same. Since two screens are provided, it is impossible to make the lecture dynamic and vivid.

(13) In the method generally used for a presentation record, as shown in FIG. 6, when the presenter is taken by a camera and is shown at a corner of the screen while showing the presentation material, the size of the presenter is too small, so the audiences tend to look at only the presentation content screen while listening to the audio.

(14) In the current method that at least two cameras are used, only the presenter is recorded, and the lecture content is combined with the recorded image, tens of minutes are needed for editing a lot of contents. It is needed to discuss if the intention of the lecturer is contained in the records, thus spending a lot of time.

(15) For the lecture using the blackboard, the lecture is recorded using one camera, the recorded one is used as an e-learning material and a remote lecture material. Since the scene of the presenter is fixed at one place, and the boring scenes are provided for a long time, so it is impossible to provide a vivid and dynamic lecture, which leads to less satisfaction.

(16) In the event that the presentation is broadcasted in real time, as shown in FIG. 7, the broadcast is proceeded using multiple cameras and switchers while switching the scenes. In this case, many experts handling the expensive equipments such as cameras, switchers or the like are needed, and it is impossible to show the screen and the lecturer in effective way. Since the experts are needed, the cost increases. For the experts of equipment, since they handle only the equipment not knowing the content of the lecture, it is impossible for the experts to perform a camera switching or the like as the lecturer intended, thus failing to make the scenes switched efficiently.

(17) What the presenter handles the equipment in person, not by the experts, is impossible during the real time presentation, so the real time lecture record is not available for now due to the above reasons.

(18) In terms of the hearing and seeing education system, the hands-on experiences and experiments are very important matters as the best method ever. The hands-on education and experiment systems are very limited at the lecture room or the experiment room. In the apparatus showing in real time a virtual image, a universal space or an undersea scene or a body image might be graphically created, and a 3D object can be created irrespective of a size and weight instead of an actual experiment. With the above system, it is possible to maximize the education effects along with an indirect experience.

As a method for significantly enhancing the lecture concentration while overcoming the above problems in terms of the presentation, only the materials from the notebook computer are not provided to the screen of the protector, but the images of the lecturer and a virtual lecture classroom are mixed and shown, so the lecturer handles the above procedure on his own without interfering with the lecture in an automatic or manual way, thus implementing an automatic lecture recoding method and a lecture transmission and a conference apparatus.

The background is removed from the video of the lecturer without changing the interior of the actual lecture room, in other words, only the lecturer is extracted and combined with the virtual classroom of a virtual graphic background along with the content of the presentation, thus forming a screen. Various combined scenes, various screens and an animated lecture are used and combined, thus creating a moving image like an advanced expensive lecture classroom, and the lecturer image can be zoomed in or out. When the lecturer describes the content, the screen is controlled in such a way that when the lecturer describes the content of the material to be presented, the lecturer's face is concentrated and zoomed in on the screen of the projector. Various lecture concentration methods are provided, in which audiences look at the screen at various angles like the broadcast screen as long as the audience looks at the screen without the audience searching for a proper screen.

The lecturer can in person design a virtual graphic lecture room, and can edit the 3D lecture room interior formed of a desk, a wall, a ceiling or the like, and the method supporting a combination of a plurality of 2D images is supported, so everyone can easily change the virtual lecture room on his own, creating a simple studio effect.

Various scenes can be zoomed in or out at multiple angles using multiple cameras during the lecture, and as in the broadcast station only the lecturer and the screen can be displayed with the aid of the virtual camera scenes and the virtual tracking motions, and the animations in which the screen or the lecturer is zoomed in or out can be presented in real time, and the lecturer can design a desired scene and creates the scenes and content which are automatically create by the mouse. It is possible to create various animated scenes along with various zoom in and out effects by one camera, and the image of the lecturer can be zoomed in and out, and the screen can be enlarged. The needed scenes can be displayed in a manual way, not by an automatic way, and the system can work without using the switching button, and the lecture concentration is not affected by the operation of the equipment.

The system according to the present invention has a function providing virtual eye-contact on the output screen so that the lecturer's eyes can contact with the audiences, by means of which the lecturer can give a lecture while having an attention from all the audiences like one to one lecture, thus maximizing the effects of lecture.

At this time, the lecturer's mouse motions are checked in order to automatically switch to a desired screen by largely switching the lecturer or the content of the lecture based on the switching operation.

When the mouse moves to the screen, the screen can be automatically enlarged, and when not moving, the lecturer image can be enlarged by using a smart program. The above construction is implemented like when a teacher starts teachings on the blackboard, the concentration can be automatically focused at the teacher at his speaking while the focus shifted to the blackboard when he starts writing on the board like an automatic timing switching function by the equipment.

A bidirectional interactive lecture can be obtained, in which the camera focuses on the lecturer in the remote classroom using the remote lecture system. Namely, the combined virtual lecture is transmitted to the remote lecture room or the conference room via the network, and the image of the remote side is shown at the side of the lecturer, which makes it possible to provide a bidirectional interactive lecture, thus obtaining a seminar, a remote lecture and a conference in an interactive way. The above features allow the lecturer to feel like he gives a lecture at the actual place.

In addition, when the above output video is recorded in real time, the skilled edit expert does not need a manual editing process following the recording, so it is possible to obtain a lecture effect exceeding the effects of above the actual real time lecture apparatus, and once the lecture is provided, it does not need to make the same lecture again on account of the use of the lecture recording apparatus of the present invention.

The mouse is designed to move the pointer to the content of the lecture, while supporting a marking, an image drawing, etc., thus drawing a picture or writing something. A virtual electronic blackboard function is provided, which allows a function of drawing on a virtual screen. When combined, an electronic blackboard function can be provided without using a separate apparatus. The color, thickness and transparency of the pen can be made in an intuitive form with the aid of a combination of mouse functions, so a user can easily select a needed color during the lecture. Even the lecturer changes the size or angle of the screen, the size or angle of the content can be changed, so the content can always match with the materials of the lecture, which is another object of the present invention.

An external camera can be seen on the virtual screen for an easier lecture, so the students asking questions and the external video are shown on the monitor, and the image reading apparatus, namely, document camera function can be provided via the camera using the USB. A mouse wheel and a clock function are provided for the above functions, so the functions can be intuitively performed without using additional equipment. In the above method, the electronic blackboard, the image reading apparatus, the switch, the video player or the like which are a common seeing hearing equipment used for the conventional lecture can be integrated into one unit, so the recording and transmission can be performed without additional equipment used. Providing the apparatus having a real time lecture recording and remote lecture and conference is the object of the present invention.

In addition, the present invention allows the lecturer to simply change and create a virtual lecture classroom. For this, various 3D virtual lecture classroom graphic tools are provided and in case of 3D, the lecturer can freely change and create various colors, and in case of 2D, it is possible to change the graphics of a plurality of 2D background layers or to use the set of the same. The lecture materials and the image of the lecturer are combined into a separate layer on the background layer, thus creating various scenes of the lecturers and lecture materials in different sizes or adjusting the same. The lecturer is given a function of automatically switching the scenes to be used during the lecture or switching the scenes using a mouse or a touch screen.

To achieve the above objects, the present invention is characterized in that various images are combined with the presentation materials and the graphic lecture studio images using a Chromakey technique which is generally used to extract the lecturer image from the background, and the combined scenes are automatically or manually switched depending on the ongoing situation of the lecture at every 5˜20 seconds, thus maximizing the effects of lectures along with the editing functions that the lecturer can easily handle.

The method of the present invention comprises a step (1) in which a certain set is selected from among the 3D background virtual lecture room sets previously prepared or made using the 3D editing program such as 3D max, thus easily editing each interior or a certain data is selected from the data provided from the data on a desk, decorations or the like which are used at the virtual lecture room, thus selecting and designing in a 3D space. The lecture room can be desired in a way of combining a plurality of layers using 2D images, and 2D graphics of a background, a wall, a desk or the like are selected or inputted into a lecture image, thus conveniently designing the virtual lecture room in graphics;

a step (2) in which during a real time lecture, a combination or rendering output scene are designed by the needed number, and the virtual screen which can be freely moved and is resizable is arranged with a certain size at a certain portion of each scene, thus outputting the scenes which are animated or can be zoomed in and out and setting specific scenes, and the virtual cameras are arranged in the virtual lecture 3D space so as to display various scenes. The present invention provides a scene editing function for rendering the scenes of the virtual lecture room by way of the virtual cameras and then setting the scenes, and the various combined scenes can be adjusted or set while adjusting the animation or scales of the position, lecturer and screen of the virtual camera, so the smart scenes can be produced during the actual lecture, and the scenes can be selected with a simple external switcher in the above step, and in terms of the 2D method, the sizes of the lecturer layer combined with a plurality of layers and the screen layer are adjusted to the size of the combined scenes needed for each scene, the procedures of which are defined as a virtual scene setting step for preparing a scene editing step;

a step (3) in which the real camera to take the lecturer is placed in a real lecture room, and the cameras taking the images of a lecturer, a real image and a student and the signals from the audio microphone, etc., need to be checked for setting;

a step (4) in which only the lecturer image is extracted camera based on a Chromakey technique from the whole image of the lecture of the presenter taken by the video, which is combined, and it is set to extract the image of the presenter from which the background is removed;

(5) a step in which it is set to capture a screen via a network in terms of a presentation material to be used during a lecture and to receive by way of an interface such as notebook computer VGA/DVI/HDMI, and the files of the power point and videos or images to be displayed during the lecture are previously set, so during the real lecture, the data are set and loaded in such a way to easily show with one touch along with the lecture on the virtual screen during the real time lecture;

(6) a script title setting step in which the titles to be used are previously arranged to show, so the lecturer can add the titles if necessary;

(7) a step for setting a first scene which displays the title of the first lecture so as to show at the time the lecture starts and the recording starts;

(8) a step for loading multiple virtual experiments and 3D data of 3D objects while moving them with one touch and inputting the virtual 3D or 2D data with the mouse in real time;

(9) an audio mixer setting step in which an audio from a lecturer and the audios contained in the videos to be used for the background are mixed to have certain levels and are outputted;

(10) a scene automatic switching setting step in which the sequence and conversion time are set for the use in an automatic scene switch based on the motions of the mouse and pen of the tablet for an automatic scene switch, thus correcting and setting the variable of the recording and automatic switches and defining the buttons needed at the external switch;

(11) a step in which at the time the compression format and the audio video compression ratio are transmitted during the recording of to the lecture, the encoder setting and combined output scenes of the network setting part are prepared to work in sync with the input of the remote conference and the program of the remote conference;

(12) a step in which the real time lecture is actually performed by way of the above processes, and the presentation materials of the lecturer are combined with the virtual scenes, and the scenes are intelligently switched, and the selected scenes are displayed, and when the lecturer writes on the blackboard, the written content is combined with the final image in the writing layer, and is outputted to the display apparatus; and

(13) a step in which a video conference and a remote lecture happen, and a plurality of remote cameras are shown in a video conference or a remote conference, and the motions of a mouse or a tablet is detected, and the size of a lecturer and a size of a presentation screen are intelligently detected, and when a mouse pointer is placed on a screen, the screen might be enlarged or letters might be enlarged, and when the motions are fixed, the size of the lecturer might be gradually increased, and the screen can be relatively decreased, and when the mouse button is clicked or the mouse wheel is spun, the front surface or the monitor contents or the titles can be adjusted with a mouse and button combination function, so the whole functions of the equipment can be adjusted by a mouse in an automatic or manual way.

The lecture apparatus of the virtual lecture classroom according to the present invention comprises:

a rendering part which combines a lecturer layer obtained from the Chromakey apparatus and a written content inputted from the tablet and a presentation material or a data of an external notebook computer are combined with a virtual studio image, thus creating the final image and outputting to the display apparatus; and the rendering of the final image is outputted from two left and right cameras for creating a 3D image, and the rendering image of the left and right sides are outputted, thus creating a 3D video screen, so the lecture can be made like real situation in such a way to display a stereo screen output.

In addition, there might be further provided an apparatus of a lecture recording and broadcast and video conference in such a way that the final images from the display apparatus are recorded, compressed and outputted.

There might be further provided a server by means of which the final images can be received from the rendering part or the lecture file storage by way of the wired or wireless network, thus supplying the final images to a plurality of client computers for the user to take lectures. The server receives the camera videos of the remote lecture room or the seminar room of the other side, thus sharing the data during the lectures.

### ADVANTAGEOUS EFFECTS

The lecture room with a beautiful interior can be made to look like a broadcast station studio in such a way to combine a lecturer and a virtual lecture room with a lecture screen, thus enhancing the concentration of a lecture, and it is possible to change the configuration for every lecture without changing a lecture room, thus saving a lot of costs.

Various viewing and hearing apparatuses, a VTR, CD/DVD player and an image reading apparatus, an electronic blackboard, etc., which are used for a lecture, can be integrated into one unit, and the selection of such device can be done by one touch method in an all-in-one system.

Once only one output video combined with a real lecture is created, it can be used multiple times, and expert camera men and cameras, audio systems, recorders and switch mixers are not needed in the present invention for recording, and the manpower for the above devices is not needed because the lecturer can operate all the devices, the system of which might be called a total broadcast system. When the recording of the lecture is finished in a certain way, and the real time lecture is finished, the recorded video provides the same lecture class as the actual class, so it does not need to give lecture again by using the video lecture. Since the lecture is recorded in real time, it is possible to actually record the important lectures at anytime.

The videos of the present invention can be recorded with only one camera not needing expensive broadcast system, thus obtaining the effects of using a number of cameras. Since the screen of the track motion like the camera effects of moving tracks can be created using the fixed camera, so it is possible to save the time and cost which increases as the lecture, recording and broadcast system are used, thus maximizing the effects of the lecture.

In the present invention, since it is possible to create the lecture like the lecturer actually gives a lecture by way of the remote lecture method via the network based on the apparatus while making an eye contact with the audience, the good looking lecture in which various scene are being switched on the screen can be provided in real time, so it is possible to provide the lecture more effective than the actual lecture, which leads to the actual application of the remote lecture system which was not actually used in the conventional art due to the problems, and the presentation conference is possible using the video conference.

When the apparatus of the present invention is applied to the lecture desk, all kinds of the hearing and seeing apparatus and an image reading apparatus are not needed, and the lecture recording and broadcast are performed at one place with one apparatus, so an advanced electronic desk can be implemented in the present invention.

In the present invention, only the lecturer image is extracted from the background using a Chromakey technique, a background image extraction method or a TOF (Time of Flight) sensor, and is combined with the presentation screen with one screen, thus providing the audience with the combined screen as shown in FIG. 8. Even when the audience looks at one portion, the audience can look at both the presentation material and the presenter. It is possible to zoom in or out the lecturer or the screen if necessary. The needed screen can be combined in real time to view both the lecturer and the screen. So, the present invention makes it possible to help the students to concentrate at the lecture with a new presentation method of the present invention.

The presenter can combine in real time the scenes for the audience to focus on with a simple operation of a mouse or a switch without seeing a menu screen in an automatic or manual way. When it is needed for the audience to focus on the material, the material is zoomed in, and when it is needed for the audience to focus on the presenter, the presenter is zoomed in on his own as the presenter uses in person a mouse of the computer, so it is possible to easily switch the material and the presenter to focus on by using a computer mouse like using a pointer. So, camera men and equipment operators are not needed. The lecturer is needed to give lecture only without the lecturer switching the scenes by using a mouse or a simple operation of a switch, so the lecturer alone can perform an equipment recording, transmission and scene switch while giving a lecture.

In case of the audience, it is needed for the audience to focus on one screen during which the audience can naturally recognize the portions that the presenter wants to emphasize. So, the necessary elements cannot be missed by the audiences, thus enhancing concentration in terms of lecture.

Since it is possible to efficiently transfer the face expression and gesture of the presenter to the audience sitting at a far place by way of a large size screen, thus obtaining the same effects as in all the positions of the large size lecture room as shown in FIG. 9.

When the presenter gives a lecture while looking at the camera, it looks like the presenter look at all the audience's eyes of the lecture room, so all the audience might feel like they have eye contacts with the lecturer in person. The present invention makes it possible to provide the effects that all the audience have eye contacts with the presenter, thus maximizing the efficiency of the presentation and significantly enhancing the concentration of the lecture as compared with the conventional lecture in which the presenter should make eye contacts while looking at multiple positions.

The apparatus of the present invention is characterized in that the camera switching operation, electronic blackboard writing operation and the scene combination switching operation can be done using one mouse. The presenter can freely control in real time all the scenes, electronic blackboard functions and the combination screen switching operation in automatic or manual ways while giving a lecture. So, the lecturer can design the lecture in his way. Since the screen can be recorded and transmitted in real time, the editing procedure is not needed, thus saving time and manpower consumption.

The present invention provides easy-to-handle environment so that the lecturer can easily design the 2D or 3D graphics while combining the lecturer and the presentation screen, so it is possible to maximize the effects of the lecture like the lecture at the good-looking lecture without setting the expensive lecture studio, thus helping the audience to focus on the lecture.

In the present invention, an ordinary person can easily select a background, desk and monitor by way of the studio design menu of the present invention even though the user is not a 3D or 2D expert, so everyone can easily design and create a dedicated studio, thus creating good-looking lecture scenes.

The present invention makes it possible to provide the audience with new virtual spaces who are bored seeing the lectures always placing at the same place, thus enhancing the concentration of the audience while obtaining an unexpected effect.

The lecture screen formed of various screens created by the presenter does not need an editing time, and the real time recording is possible, so the present invention can be well applied to a real time recorder which can be used for a material manufacture as in an e-learning system.

In addition, the outputted videos are compressed and easily transmitted to a remote place, which allows a remote conference and a remote lecture which was not possible in the past. The combined lecture seen at the remote place has better lecture effects than the actual lecture, and since the eye contacts occurs between all the audience and the lecturer, an excellent remote lecture and a remote conference system can be implemented.

The combination method according to the present invention is directed to integrating the functions of a virtual electronic blackboard function using a tablet providing drawing and writing functions on the screen during the presentation, an image reading function by way of an external USB camera and a previously recorded and prepared audio/video reproduction function into one apparatus, so it is possible to eliminate any inconveniences that multiple devices are prepared in the conventional art, and all the functions can be implemented in one apparatus.

In particular, the electronic blackboard making it possible to draw or write on the presentation screen and the virtual screen blackboard function making it possible to display on the virtual screen are provided. Even when the sizes of the presentation screen differently change on the output screen, the written content of the electronic blackboard can be zoomed in or out, thus providing the electronic blackboard function of the virtual lecture room screen.

The prior part patents are directed to the recording of the presentation using a 3D virtual studio technology; whereas the present invention is basically directed to providing a total type 3D graphic as well as 2D multi layer combination. The TOF method as well as Chromakey technology can be implemented for a background image extraction method. So, it is possible to cut the screen of the lecturer video in an elliptical shape under the environment that the Chromakey is hard to use, and the contour portions are processed to be visible and smooth and are combined to a virtual space, the technology of which seems to be a new presenter extraction method. In particular, the present invention provides a new VR presentation technique which makes it possible for a lecturer to easily control the functions of a scene switch, a virtual camera, an electronic blackboard, an image reading apparatus and a video and photo provided from the apparatus of the present invention without looking at the screen with the aid of a simple mouse operation, the method of which was not taught in the conventional art in which the presenter cannot focus on the lecture when the lecturer gives a lecture while looking at the GUI/menu and handling the equipment.

### BRIEF DESCRIPTION OF THE DRAWINGS

The present invention will become better understood with reference to the accompanying drawings which are given only by way of illustration and thus are not limitative of the present invention, wherein;

FIG. 1 is a view of an occasion that an audience's attention is divided into a presenter and presentation content;

FIG. 2 is a view of an occasion that a concentration is lowered as a presenter looks smaller as compared with a relatively larger screen, and the audience's attention is focused on only the presentation content, and there are not eye contacts between the audience and the presenter, and the audience focus on only the voice of the presenter;

FIG. 3 is a view of an occasion that for an audience sitting far from the presenter, a presenter's face expression and body gesture are not transferred, so the efficiency of the presentation is lowered;

FIG. 4 is a view of an occasion that when at least two screens are provided, and a lecturer is separately displayed on an additional screen, the lecturer and the content screen are separated, so the audience's concentrations are lowered;

FIG. 5 is a view of a presentation method in which a presenter and a presentation material are displayed on different screens;

FIG. 6 is a view of a method in which a presenter is taken by a camera and is displayed at one corner portion, and a presentation content is displayed on the same screen;

FIG. 7 is a view of an occasion that a broadcast is performed while switching presentation scenes using multiple cameras and a switcher;

FIG. 8 is a view of an occasion that only a presenter is extracted and combined with a presentation content in one screen, thus displaying the combined content to the audience according to an embodiment of the present invention;

FIG. 9 is a view of an occasion that a face expression and body gesture can be efficiently transferred to the audience sitting far by way of a large size screen;

FIG. 10 is a flow chart of a virtual studio lecture method using a background image separation method for the content which can be described by way of a Chromakey method among various methods separating a presenter from a background in terms of a video inputted from a camera according to the present invention;

FIG. 11 is a view illustrating an example of a Chromakey procedure in the step S300 of the virtual studio lecture method using a Chromakey according to an embodiment of the present invention;

FIG. 12 is a view of a layer combination procedure in the step S400 of the virtual studio lecture method using a Chromakey according to an embodiment of the present invention;

FIG. 13 is a view of the final image of the virtual studio lecture method using a Chromakey according to an embodiment of the present invention;

FIG. 14 is a view of a written content layer combination procedure of the virtual studio lecture method using a Chromakey according to an embodiment of the present invention;

FIG. 15 is a block diagram of the virtual studio lecture apparatus using a Chromakey according to an embodiment of the present invention;

FIG. 16 is a block diagram of a layer combination apparatus of the virtual studio lecture apparatus using a Chromakey according to an embodiment of the present invention;

FIG. 17 is a view of a button of a switch for selecting an output screen of a virtual lecture room using a Chromakey technique, namely, an output screen of multiple cameras or at various positions according to an embodiment of the present invention;

FIG. 18 is a view of a basic operation principle showing a lecturer image Chromakey extraction function and a graphic screen combination function of an apparatus according to the present invention;

FIG. 19 is a view of an operation principle of an apparatus according to the present invention;

FIG. 20 is a view of a necessary element for the operation of an apparatus according to the present invention;

FIG. 21 is a view of embodying in details and expressing the functions of a necessary element of FIG. 20;

FIG. 22 is a view illustrating a configuration of a touch menu according to an embodiment of the present invention;

FIG. 23 is a view illustrating a configuration of an additional external switcher menu according to an embodiment of the present invention;

FIG. 24 is a view of a configuration of a screen selection according to an embodiment of the present invention;

FIG. 25 is a view of a configuration of a function of an electronic blackboard on a virtual screen according to an embodiment of the present invention;

FIG. 26 is a view of a configuration that a 3D object can be seen in a virtual space with the aid of a 3D max or Maya according to an embodiment of the present invention;

FIG. 27 is a view of a remote conference in a way that an image of a presenter is extracted and combined with a presentation material and is outputted by way of the apparatus according to an embodiment of the present invention;

FIG. 28 is a view of a shape of an electronic lecture desk according to an embodiment of the present invention;

FIG. 29 is a view of a construction that a presenter presents while looking at an output screen of a front screen along with the audience sitting at a rear side according to an embodiment of the present invention; and

FIG. 30 is a view of a construction that a plurality of screens are disposed, and different materials are displayed from each screen, thus forming a virtual blackboard according to an embodiment of the present invention.

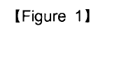

### MODES FOR CARRYING OUT THE INVENTION

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

Throughout the specification, the term “connected” to other elements means “direct connection” or “indirect connection with something being disposed between the elements to be connected”, and the term “comprise” means a wider range of inclusion, namely, it might mean further including others other than the element basically included, unless otherwise stated.

The apparatus of the present invention is directed to extracting an image of a presenter from a background during a real time presentation, a real time lecture recording or a remote presentation and to combining the hearing and seeing material contents needed for the presentation with a 2D or 3D virtual graphic lecture room and to displaying like the scenes are switched by multiple cameras at a virtual lecture room studio, so it is possible for a lecturer to automatically operating a real time lecture recording, transmission and presentation conference using the above method of the present invention. Here, in terms of the operation of the present invention, a desired scene is switched as a lecturer clicks with one mouse without looking at a main menu like a common presentation, so the lecturer can focus on the content of the presentation, and the apparatus operation and the presentation hearing and seeing material switches are integrated and driven, and the functions of various hearing and seeing apparatus can be integrated into one device, so with one touch, the electronic blackboard function and the image reading functions can be activated. In addition, as compared to a simple construction in which the audience keeps boringly looking at the blackboard or the screen, the audience can look at both the presenter and the content on the screen, and the image of the presenter can be zoomed in, and the content can be zoomed out, thus creating various scenes in real time. When the audience needs to look at the lecturer, the image of the lecturer is zoomed in, and when the audience needs to look at the content, the content is zoomed in. The presenter can to easily control the function of the screen of the notebook computer, the document files, external cameras or video files and photos with the mouse or a simple switching button, so it is possible to help the lecturer to efficiently give the lecture with the aid of the controls of the needed scenes and presentation.

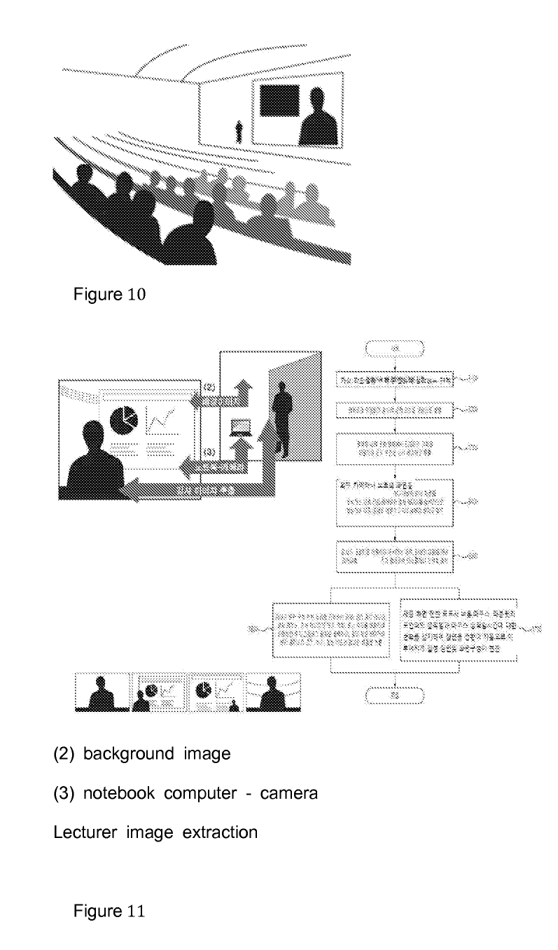

FIG. 10 is a flow chart of a method of a virtual studio lecture in such a way that a Chromakey technique is selected from among various methods of separating a video presenter from a background inputted from a camera according to an embodiment of the present invention. As shown therein, the lecture method based on a virtual lecture room recombination screen using a Chromakey technique according to an embodiment of the present invention comprises a step S100 in which a plurality of 2D layers are combined, thus creating a virtual lecture room, and selecting or editing a 3D virtual lecture room, a step S200 in which the shape of the lecturer is taken using the camera, a step S300 in which only the shape of the lecturer is extracted from the taken lecture shape using a Chromakey technique, a step S400 in which a lecturer presentation layer indicating at least lecture material (notebook computer screen, camera including an external VTR, an image reading USB camera, motion picture) in the background layer and a lecturer layer, and the combined screen is outputted to the display device, a step S500 in which when the lecturer writes on the blackboard using a tablet, the written content is combined with the screen showing the presentation material, and the combined content is outputted to the display apparatus, a virtual blackboard step S600 in which in case that the lecturer handles a screen construction conversion device, the lecture material layer, lecturer layer, the size, position or angle of the written content layer are recombined and outputted to the display device, and the lecture material layer, the size, position and angle of the written content layer are converted at the same aspect ratios despite of the change of the screen, and a step S700 in which when the auto screen switch button of the screen construction conversion device is on, the switch of the scenes are intuitively performed based on the operation of the mouse curser or the button, and as the time set to the scene switch lapses, the material layer of the lecture, the size, position and angle of the written content layer are recombined automatically, and outputted to the display device, and the lecture material layer and the size, position and angle of the written content layer are converted at the same aspect ratios. So, the switches of all the apparatus and the scenes needed for the lecture can be performed with the motion of a mouse pointer of the lecturer and the simple operation of the left or right button or central wheel of the mouse.

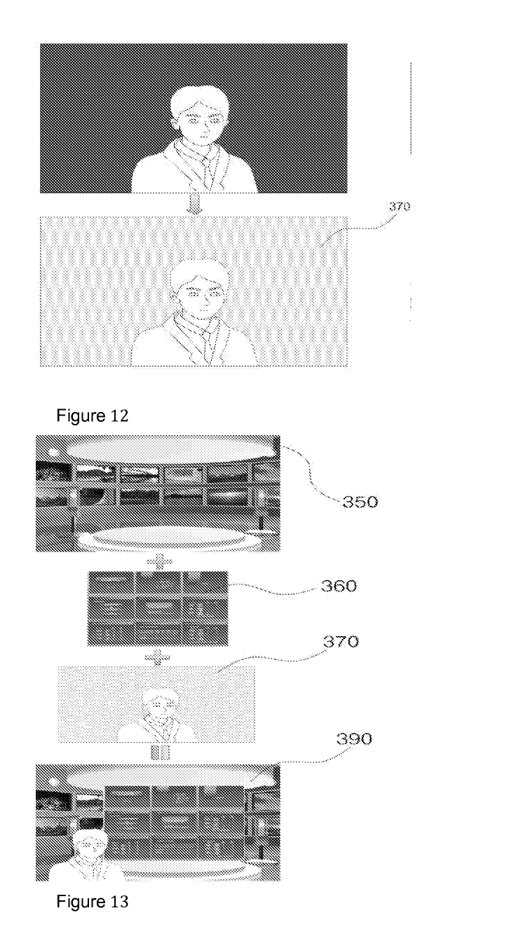

In the step S100, the 3D background (350 of FIG. 12) can be selected to form a virtual lecture room to be used by combining multiple 2D layers or can be previously provided or manufactured, and the virtual lecture room to be used for the lecture is selected, and the color background images are changed in terms of the change of the interior and are designed and stored. At this time the virtual lecture room uses a 2D or 3D graphic image of the lecture room of the universal space, and the interior of the human body, thus obtaining a hands-on education system which was not disclosed in the conventional lecture method. At this time, the present invention provides a function of the 3D background layer (350 of FIG. 12) as well as the 2 background layer (350 of FIG. 12), and the inner screen is edited, and the edited data are stored. The sea or wide field photos can be used as the background image, and the good-looking scenes for the lecturer to look at are used, thus enhancing the concentration of the lecture. At this time, the nine buttons are designed as examples as shown in FIG. 13 by way of the scene editor combining the lecturer and screen and the background with the lecture image, and the region of the background is adjusted together. The above scenes are switched automatically or manually using the time or the position of the mouse or the mouse buttons and the rotation wheels, so the switches are automatically and manually performed, and the scene switches are performed at every 5˜20 seconds, thus enhancing the concentration of the audience.

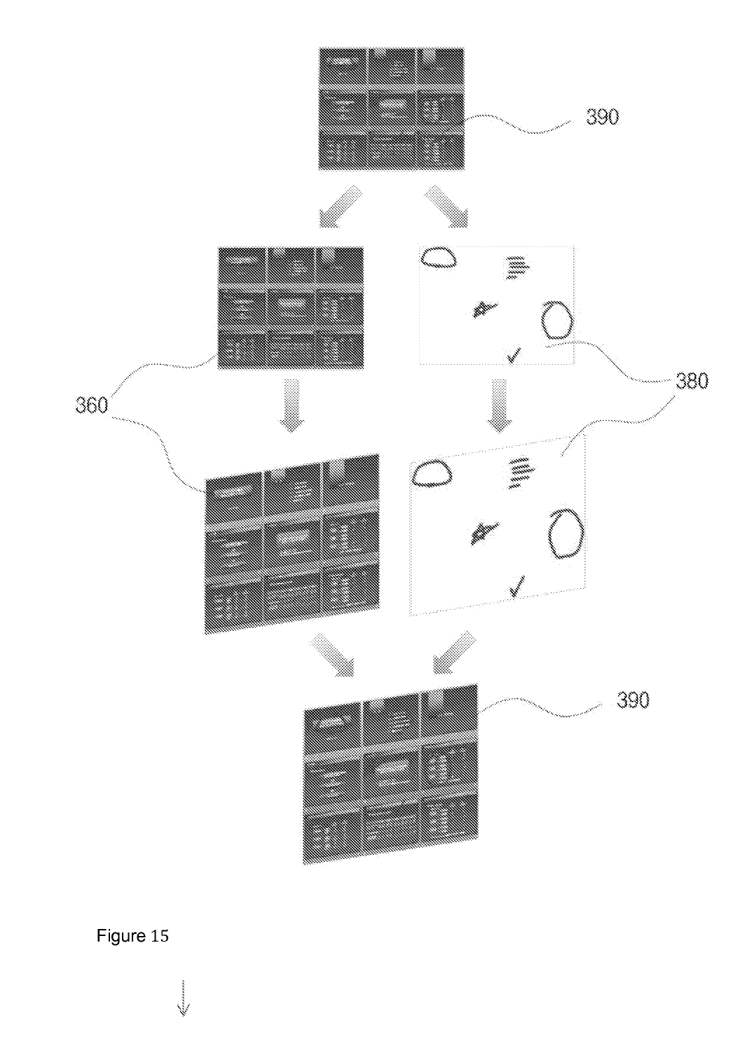

In the step S200, the lecture image of the lecturer is taken using the camera 100 of FIG. 15. For the efficient removal of the background using Chromakey technique, it is preferred to use the Chromakey technique for separating the image of the lecturer from the background and the TOF sensor for measuring the positions of the lecturer or a camera 100 of FIG. 15 for extracting the image of only the lecturer. In the step S300, only the image of the lecturer is extracted as a form of the lecturer layer 370 of FIG. 11, by way of the Chromakey technique from the taken image of the lecture. In the step S300, the above construction will be described in details with reference to FIG. 11.

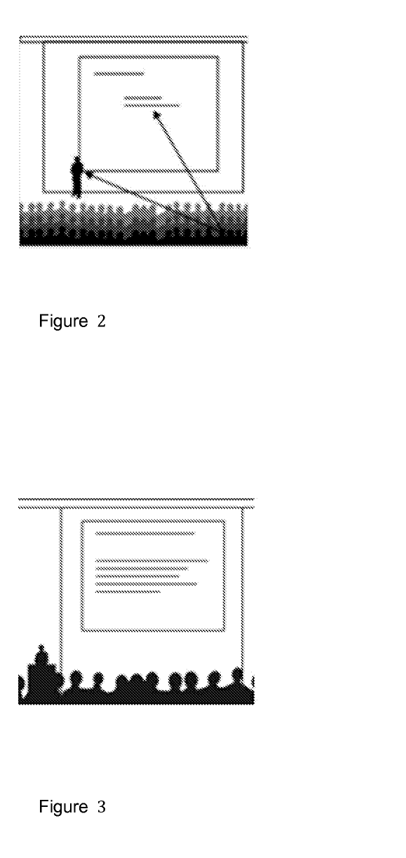

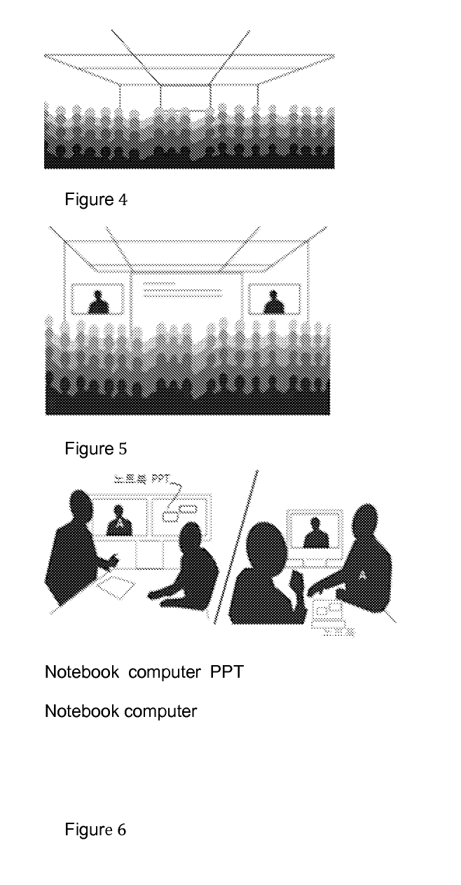

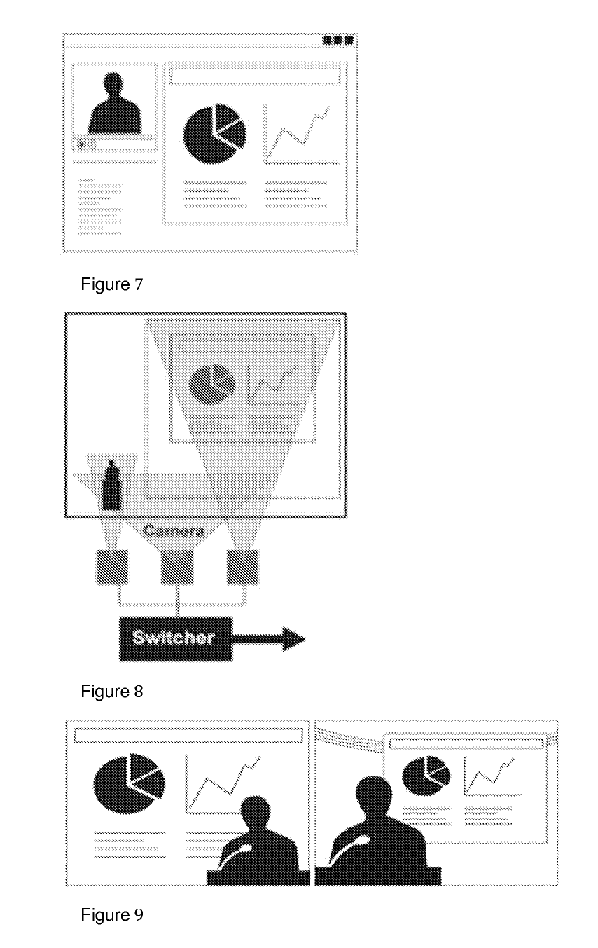

FIG. 11 is a view illustrating an example of the Chromakey procedure in the step S300 of the virtual studio lecture method using a Chromakey method according to an embodiment of the present invention. Here, the Chromakey technique is characterized in that the object with a background is taken, and only the background is removed, thus forming a blank corresponding to the removed background, which is generally used for combining the object with another image. As shown in FIG. 11, in the step 300 of the virtual studio lecture method using a Chromakey technique according to an embodiment of the present invention, only the image of the lecturer is extracted using the Chromakey technique, and the background layer 350 of FIG. 12 and the lecture material layer 360 of FIG. 3 of the lecture material layer are combined, thus creating one final image 390 of FIG. 12, so the lecturer feels like he is actually at the virtual lecture room, and the audience is provided with the god looking screen, thus enhancing a concentration, and the background is moved while various scenes being switched, thus creating the lecture room like the actual lecture room. The problems that the material reproduction screen and the screen of outputting the image of the lecturer are separated are overcome. The space of the lecturer is displayed on the screen, and the other portions display the presentation material, thus saving the spaces of the presentation and since the virtual environment is provided, thus obtaining a virtual learning experience. At this time, when it is hard to extract only the lecture image using the Chromakey technique, the portion of the lecturer is extracted in an elliptical shape or a circular shape for the intensive concentration, a transparency might be given to the edge portion, thus enhancing lecture concentration. So, even when the Chromakey technique is not actually adapted when removing the background, it is possible to obtain the maximum effects in terms of recording the lecture.

In the step S400, the lecture presentation material layer 360 of FIG. 12 and the lecturer layer 370 are combined with the background layer 350 of FIG. 12, which layer 360 indicates the material of at least one lecture material and the image reading apparatus, a motion image and photo showing the USB camera of the notebook computer screen or external camera and image reading apparatus, thus creating the final image 390 of FIG. 12 and outputting to the display device 400 of FIG. 15. The step S400 will be described in detail with reference to FIG. 12.

FIG. 12 is a view of a layer combination procedure in the step S400 of the virtual studio lecture method using a Chromakey technique according to an embodiment of the present invention. As shown in FIG. 12, in the step S400 of the virtual studio lecture method using a Chromakey technique according to an embodiment of the present invention, the background layer 50 is set as the background, and the lecture material layer 350 and the lecturer layer 370 are combined thereon. It is obvious that the combined layer is formed in such a way to input the layer with a transparency in front of the background and the lecturer in single or multiple numbers, thus adding the decorations such as a desk or tree. The scenes seen from left and right eyes can be outputted, thus creating a 3D image like the above 3D creation procedure. The layers are combined in real time, and the final image 390 is outputted to the display device 400 of FIG. 15, so the lecturer can give a lecture using the final image 390 combined with the lecture materials while looking at the image of the camera.

During the combination, they are combined in a sequence of the background layer 350, the lecture presentation material layer 360, and the lecturer layer 370, so the audience can look at both the lecture material and the lecturer. Here, the lecture material layer 360 might be formed in a rectangular shape like the lecture material is presented on the virtual monitor or a shape formed by extracting a specific portion to be displayed to the audience. In addition, the lecture materials might be provided in multiple numbers, and it is needed to properly combine the lecture material layers 360, not overlaying the same. When it is needed to combine the lecturer layer 370 extracted in the step S300 with the background layer 350, the lecture is not overlapped with the shape of the lecturer.

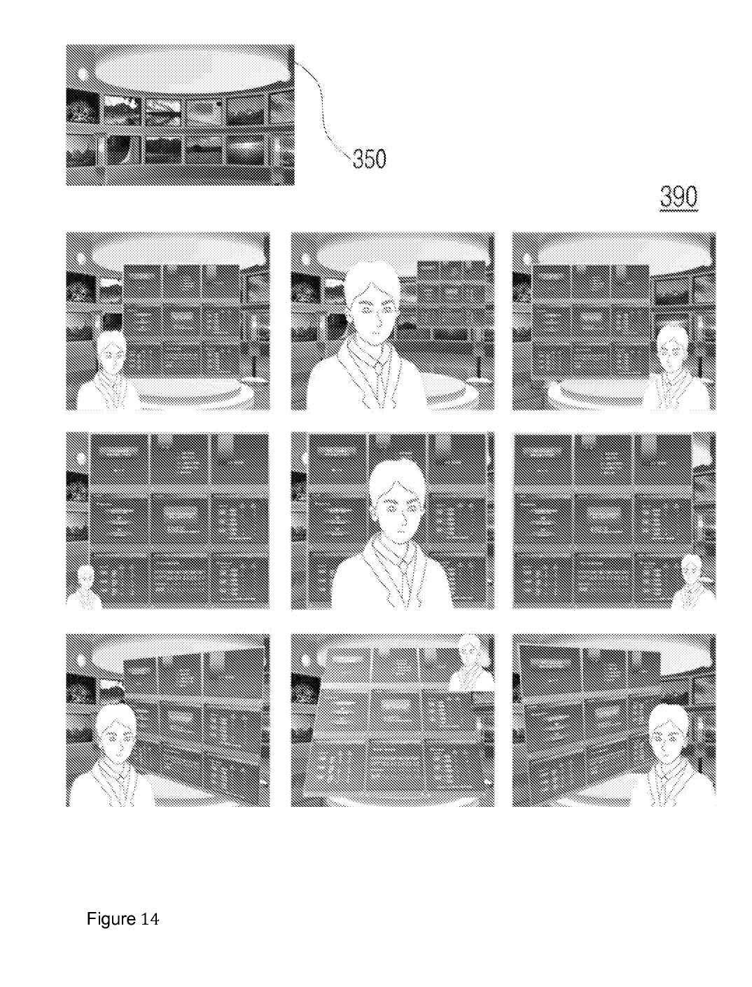

In the step S500, when the lecturer writes using the tablet 600 of FIG. 15, the written content is combined with the final image 390 in the form of the written layer 380 of FIG. 14 and is outputted to the display apparatus. While the lecturer explains the prepared lecture material to the audience, a certain portion in the content of the lecture can be underlined to clarify the content of the lecture or can be emphasized with a color mark, for which the present invention is characterized in that the lecturer can underline using the tablet 600 of FIG. 15, and the underline is combined with the final image 390. The underline and the written layer 380 of FIG. 14 is marked on the lecture material layer.

In the step S600, when the lecturer handles the screen construction conversion apparatus 500 of FIG. 15, the size, position and angles of the lecture material layer 360, the lecturer layer 370 and the written layer 380 of FIG. 14 can be recombined and outputted to the display apparatus 400 of FIG. 15, and the size, position and angle of the lecture material layer 360 and the written layer 360 of FIG. 14 can be converted at the same conversion aspect ratio. The step S600 will be described in details with reference to FIGS. 13 and 14.

FIG. 13 is a view of the final images of the virtual studio lecture method using a Chromakey technique according to an embodiment of the present invention. As shown in FIG. 13, in the step S600 of the virtual studio lecture method using a Chromakey technique according to an embodiment of the present invention, as the lecturer handles the screen construction conversion apparatus 500 of FIG. 15, the size, position and angle of each layer are converted and recombined, thus making the final images 390 in different forms. When the lecturer wants to zoom in the letter recorded in the lecture material or it is needed to zoom in the image of the lecturer, the final image 390 can be selected for each situation, thus effectively performing the lecture. As the lecture goes along to while changing the final images 30 with different constructions, the audience can concentrate at the lecture, and the contents of the lecture can be easily transferred.

FIG. 14 is a view of a written layer combination procedure of a virtual studio lecture method using a Chromakey technique according to an embodiment of the present invention. In the step S600 of the virtual studio lecture method using a Chromakey technique according to an embodiment of the present invention, the lecture material layer 360 as well as the written layer 380 are converted and recombined. When the size, position and angle of the written layer 380 are converted differently from the size, position and angle of the lecture material layer 360, the written layer cannot properly match with the lecture material. In the step S600, the lecture material layer 360 and the written layer 380 are converted and recombined at the same aspect ratio, so even when the lecture material is changed, the written layer can be positioned in place.

In the step S700, when the auto screen conversion button of the screen construction conversion apparatus 500 of FIG. 15 is on, as the set time lapses, the size, position and angle of the lecture material layer 360, the lecturer layer 370 and the written layer 380 are repeatedly converted and recombined and outputted to the display apparatus 400 of FIG. 15, so the size, position and angle of the lecture material later 360 and the written layer 380 are converted at the same aspect ratio. The lecturer can easily change the construction of the final image 390 using the screen construction conversion apparatus 500 of FIG. 15; however handling the screen construction conversion apparatus 500 of FIG. 15 might lower the concentration of the lecture in the course of lecture, and the above procedure might be inconvenient during the real time lecture, so in the step S700, when the lecturer turns on the auto screen switch button, and when the set time lapses or the motion of the mouse stays at the virtual presentation screen of the screen, the screen can intuitively, automatically controlled by way of the adjustment of the left and right mouse click or wheel, so the lecture can be automatically switched like the broadcast without using the equipment, whereby the construction of the final image 390 can be automatically changed, by means of which the audience does not feel boring, and the concentration of the audience can be significantly enhanced. The functions can be edited so that the time or mouse motions can be set, and the intelligent function of the present invention can help known the lecturer's intention based on the changes of the mouse pointer. Namely, when the mouse is placed at the presentation screen, the screen is zoomed in, and when the mouse continues to move, the screen can be set to be gradually zoomed in. When the mouse moves in left and right directions in the presentation screen region of the portion of the lecture image, the lecturer image can be set to automatically move in the opposite direction of the presentation screen, automatically switching the scenes. The scene switch can be automatically performed in terms of the intellectual lecture. When the lecturer gives a lecture, the scenes switch. So, it is possible for the presenter to create the broadcast scenes without using external operations and experts which to are the key subject matter of the present invention.

FIG. 15 is a block diagram of a virtual studio lecture apparatus using a Chromakey technique according to an embodiment of the present invention. As shown in FIG. 15, the virtual studio lecture apparatus 10 using a Chromakey technique according to an embodiment of the present invention comprises a camera 100, a background removal apparatus 200 using a Chromakey method, a 2D or 3D layer combination apparatus 300, a display apparatus 400, a screen construction conversion apparatus 500, a tablet 600, a lecture file storage 700, a microphone 800, and a server 900 (if necessary).

The camera 100 takes the image of the lecturer and includes a tripod (not shown). The camera 100 has the same operation as in the step S200, the descriptions thereof will be omitted.

The Chromakey apparatus 200 is designed to eliminate the background components from the lecture image that the camera 100 takes, thus extracting only the image of the lecturer as a lecturer layer 370. The procedure that the Chromakey apparatus 200 extracts the lecturer layer 370 is shown in FIG. 2. Since the Chromakey apparatus performs the same procedure as in the step S300, the detailed description of the same will be omitted.

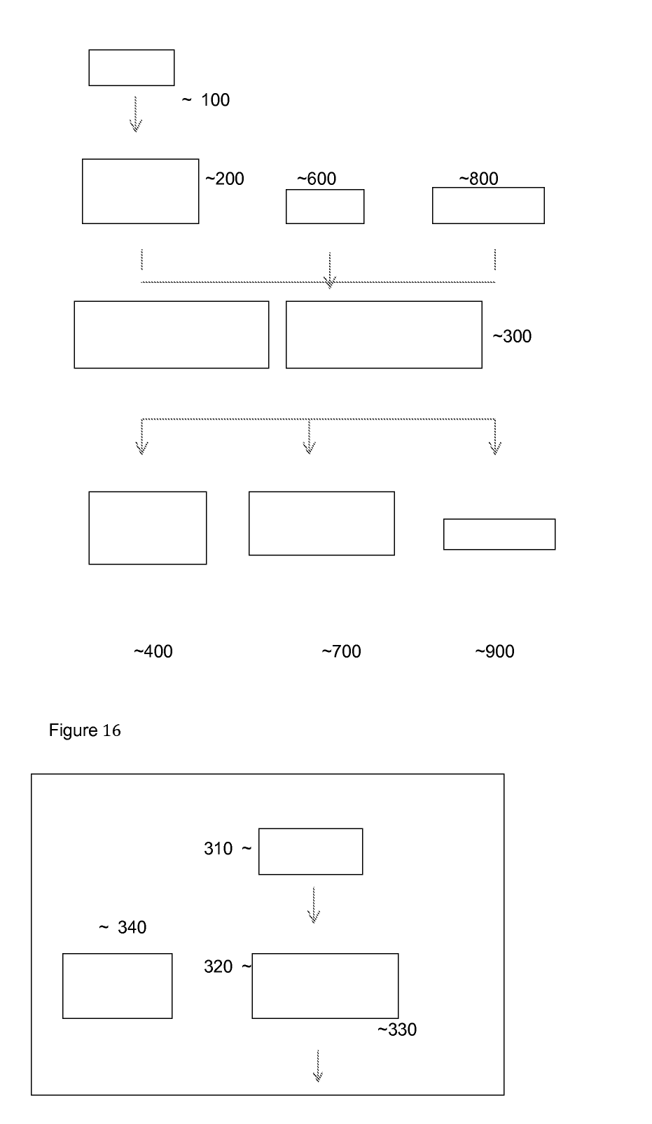

The layer combining apparatus 300 combines the previously stored background layer 350 and the lecture material layer 360, thus forming a virtual lecture room image. The lecturer layer 370 formed by the Chromakey apparatus 200 and the written layer 380 created as the lecturer writes using the tablet 600 are combined on the virtual lecture room graphic image, thus forming the final image 390. For the layer combination apparatus 300, it will be described in detail with reference to FIG. 16.

FIG. 16 is a block diagram of a layer combining apparatus of a virtual graphic lecture room apparatus using a Chromakey technique according to an embodiment of the present invention. As shown in FIG. 16, the layer combining apparatus 300 of the virtual lecture room lecture apparatus 10 using the Chromakey technique according to an embodiment of the present invention comprises a database 310, a virtual studio creation part 320, a rendering part 33 and a screen conversion part 340.

The database 310 stores the background layer 350, the floor, ceiling and desk DB to be used to change interior, and the materials needed for lectures. The background layer 350 is the same as in the step S100, so its description will be omitted. The lecture material is formed of an external video device for showing a student who asks question, and a lecturer in real time, an external connector input such as a notebook computer, and VGA, a streaming material received by way of IP, and a motion file such as AVI format data, a web material, photos, MS word and power point files. The materials considered to be used as the education materials can be used in real time on the virtual screen, and at least two external data can be displayed on a single screen or multiple screens.

The virtual studio creation part 320 creates the image of a real time virtual graphic lecture scene creating a video by way of a real time combining method of a multi layer method using the materials of the lecture on the 2D or 3D background layer 350 and a rendering method in real time along with a lecture material and a lecturer in the 3D virtual lecture room. The lecture materials are used as the lecture material layer 360, thus creating the image of the real time virtual graphic lecture scene.

The virtual studio images are previously created before the lecturer layer 370 is crated, which layer needs the Chromakey technique, thus reducing the time needed for the creation of the final image 390.

The rendering part 330 combines the lecturer layer 370 created by the Chromakey apparatus 200 and the written layer 380 from the tablet 600, thus creating the final image 390 and outputting to the display apparatus 400. The rendering part 300 might further combine the voice of the lecturer inputted by way of the microphone 800 with the final image 390. When the rendering such as a graphic combination needs some time, an audio portion might be delayed. At this time, the rendering part 330 creates the final image 390 in real time depending on the inputs of each layer and the voice and is transmitted, so the audience being at a remote place can have the virtual lecture room scene in real time, so the audience have the lecture like looking at the broadcast of the virtual lecture room, thus obtaining outstanding effects more than the actual lecture room.

The screen conversion part 340 allows the rendering part 330 to change the size, position and angle of the lecture material layer to 360, the lecturer layer 370 and the written layer 380 with the aid of the construction of the final image that the lecturer selects using the screen construction conversion apparatus 500 and to recombine the same. The screen conversion part 340 performs the same as in the step S600, so the detailed description will be omitted. Instead, in this embodiment, the lecturer does not select the final image 390 in person, but turns on the auto screen conversion button of the screen construction conversion apparatus 50 a result of which the same operation can be performed.

The display apparatus 400 outputs the final image 390 created by the layer combining apparatus 300, and it is obvious that the LCD monitor as well as the projector can be used for the display apparatus 400. The 3D lecture room can be created using the 3D glasses with the aid of the stereo display apparatus which shows a 3D image. All kinds of the equipments having the same functions as the image output functions can be used.

The screen construction conversion apparatus 500 provides a simple, intuitive switch serving to select the previously set scenes of the construction of the final image 390 by controlling the size, position and angle of the lecture material layer 360, the lecturer layer 370 and the written layer 380 combined with the final image 390 by means of the scene switch, thus providing the simple, intuitive switch, so it is possible to control the scenes with an external button in real time. The scene construction conversion apparatus 500 will be described in detail with reference to FIG. 17.

FIG. 17 is a view of a button of a switch for selecting an output screen from an output screen of a virtual lecture room using a Chromakey technique according to an embodiment of the present invention, namely, an output screen of multiple virtual cameras or at various positions. The button might be formed of a touch type screen or a button type pad. As the lecturer pushes the button in the course of lecture, a desired scene can be displayed as the lecturer orders based on an automatic scene switch. Here, the screen construction conversion apparatus 500 might have auto screen conversion buttons, and the auto screen conversion might be possible in such a way to automatically detect a specific time, the motion of mouse or the motion of the tablet pointer. So, the lecture concentration of the audience can be enhanced by changing the construction of the final image 390.

The tablet 60 is designed to receive the lecture content that the lecturer writes and to transmit to the layer combining apparatus 300. At this time, the tablet 600 provides a function of automatically setting the color, thickness and transparency of the written layer, so the lecturer can freely write as he wishes. It is preferred that the written lecture content is provided in an image layer format, not in a text form, and is transmitted to the layer combining apparatus 300 for a combination of the scenes. Even when the presentation materials displayed on the virtual screen of the virtual lecture room change at each scene, the mark or images of the screen can be set to move together with the aid of the virtual blackboard function.

The lecture file storage 700 records the final image 390 from the display apparatus 300 and stores them in a file format. When the final image 390 is provided to the audience in real time, the final image 390 is recorded into the file storage 700, which can be applied for multiple purposes as education materials. According to another embodiment of the present invention, the stored lecture file can be stored in a DVD format for a lecture.

The microphone 800 serves to receive the voice of the lecturer. The lecturer generally gives a lecture in the form of voice. When the final image 390 is stored in the lecture file storage 700 in the form of file, the voice of the lecturer is received and added to the final image 390. The present invention uses the microphone 800 for recording the voice of the lecturer into the file.

The server 900 serves to receive the data from the rendering part 330 or the lecture file storage 700 by way of the wired or wireless network and provides the final image 390 to multiple client computers connected for the virtual studio lecture. As the server 900 receives the final image 390 from the rendering part 330 and provides in real time to the client computers, thus implementing a remote lecture. Since the lecture files stored in the lecture file storage 700 are transmitted by way of the wired or wireless network, thus creating a VOD lecture service.

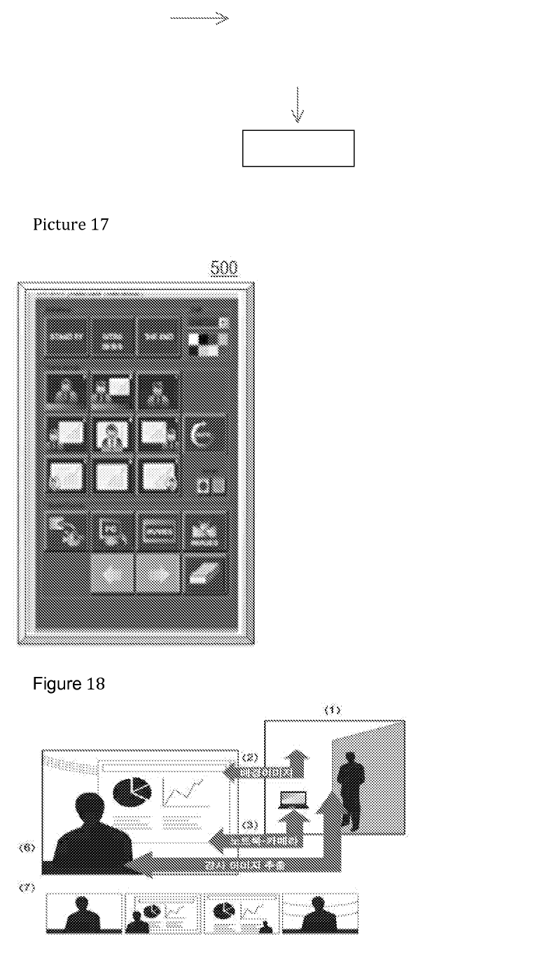

The principles of the above operations on the apparatuses are shown in FIG. 18 in graphics. FIG. 18 is a view showing a basic operation principle of the lecturer image Chromakey extraction function and the graphic screen combining function of the apparatus according to the present invention.

<1> The presenter is taken from the space where the presentation is actually held, and only the presenter is extracted from the background by the Chromakey method. The image extraction might be performed by one among a Chromakey method using color and brightness, a method extracting only the image of the lecturer placed a certain distance using the TOF (Time of Flight) sensor measuring the distance from the camera to the lecturer, and a method cutting the lecture in an elliptical shape and providing a certain transparency along an edge portion of the cut surface and combining the same without extracting.

<2> The presenter and the notebook computer VGA signal screen (or actual image of the camera signal) are combined with the background image in certain sizes, thus creating the lecture scene like in the virtual graphic lecture room. The graphic background image is provided with a 2D or 3D edition function so that the lecturer can easily edit.

<3> The representation materials such as a notebook computer, a camera, an electronic background, etc. are inputted via the IP in the form of DVI/VGA signals, and the above signal inputs can be performed by a simple mouse motion (in a way of rotating the wheel after the right button is clicked, and a way of pressing a numeral button), so the student might be displayed, who asks a question in the course of the lecture or the camera taking an actual image can be shown, and the to notebook computer might be selected, and the lecturer combined with a virtual space is virtually combined in a desired size, thus showing the image <6> in real time.

<7> A combination of the scenes to be presented during the lecture is adjusted before lecture, and the above scene is prepared for the purpose of a large size presentation or is prepared for the purpose of a presentation of a smaller lecturer. In the present invention, the scenes needed during the lecture can be automatically or manually switched. Each function of the apparatus of the present invention comes to operate with a simple operation of a common mouse (an allocation to a switching button of a numeric plate), thus easily creating the combined output scenes in real time like in <7>. The functions of a scene switch, a presentation content control, a writing and marking on a presentation screen and a drawing are provided and work in real time and intuitively without the operator having burden, so it is possible to operate while looking at the output screen of the apparatus of the invention <6> without using an additional menu screen. The convenience can be enhanced by providing an external apparatus operation help or an apparatus menu in the form of an external touch menu; however an ordinary person, not skilled person, is hard to control the above external operation apparatuses during a real time lecture, so the present invention provides an operation panel for an assistant operator to easily perform the lecture without using the mouse. There might be provided a function of receiving a pen input of the external tablet for the purpose of a marking and a drawing on the virtual screen of the presentation screen like the electronic blackboard which comes along with a marking and drawing function on the virtual screen, so it is possible to express an accurate drawing function better than the drawing with a mouse.

The video recording function of in real time compressing and storing the output screen of the apparatus of the present invention and the real time transmission of the same help implement the remote lecture and the conference. In other words, the lecture is made by the real time recording apparatus, the remote lecture apparatus and the conference apparatus, and the electronic lecture desk, namely, the lecture desk with the control function of various external devices is included in the virtual lecture apparatus using the apparatus of the present invention, so it is possible to create the electronic lecture desk with the presentation control, the real time lecture recording and the virtual reality presentation functions without using a special equipment.

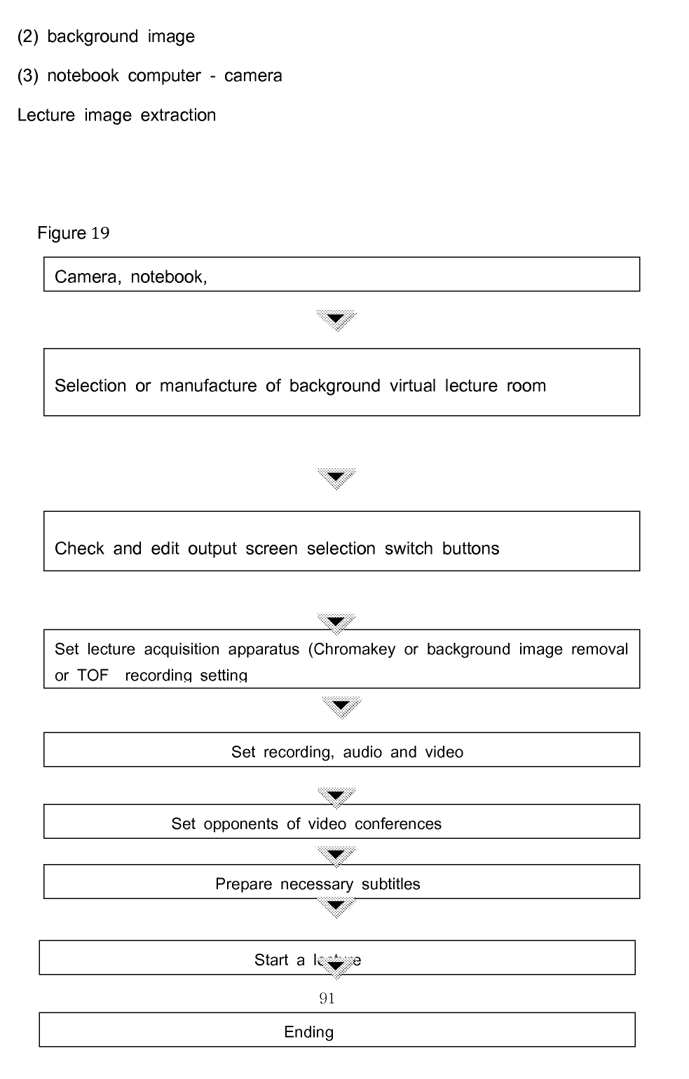

FIG. 19 is a view of an operation principle of the apparatus according to the present invention. As shown therein, the presenter can easily change the screen while giving a lecture with the presentation material such as a notebook computer or the like during the presentation, and it is possible to draw a picture with a mouse on the virtual presentation screen with the combined output scene. The presenter might use a tablet for a finer picture. The presenter switches the scenes while looking at the output screen 10, and draws a mark or a picture by moving the mouse pointer on the screen during the lecture. The continuous change in the output screen within 5˜20 seconds is provided with the moue button, so the audience is provided with variously angled screens like the operations by the cameras of the broadcast station, which helps concentrate audience. At this time, the present invention provides an auto switching function to overcome the problems when the scenes do not switch for a set time since the presenter has intensive focus on the content of the presentation. The automatic switching function helps automatically switch the scenes to similar scenes by comparing with the previous scenes, so the presentation does not become boring. In addition, there is further provided a function of allowing the necessary scenes to automatically move with the aid of the motion of the mouse button. When the mouse does not move for a set time period, the image of the presenter is automatically zoomed in, and the presentation screen is zoomed out, and when the mouse starts moving on the screen and marking, the presentation screen is zoomed in, and the lecture is zoomed out in the auto mode, so the lecture can provide an intensive focus on the lecture while automatically switching the scenes. In addition, if necessary, as the presenter clicks a certain portion of the presentation scene with the right mouse button, the content of the presentation material is zoomed in, and in case of vice versa it is zoomed out, so the scenes of the lecture can be easily created.

(1) Only the image of the lecturer is in real time taken following determining the distance difference between the lecturer and the video pixel of the background object in the actual space by using the sensor of the extraction apparatus (Chromakey, background image comparison removal, TOF (Time of Flight) used to separate the lecturer and background from the image that the lecturer has taken, thus in real time obtaining only the lecturer image.

(2) The notebook computer input of the lecturer is taken as the signals of VGA, IP or HDMI, and further by way of the external camera, and the actual image scenes and the students are shown on the virtual screen. The virtual screen is designed to display the scenes at one time or in a switching manner on a single screen or a plurality of screens.

(3) The files of the video, image, PPT, etc. are selected from the USB or internal storage for the purpose of use during the lecture, and the files are sequentially displayed on the virtual screen with the operation of the moue scroll.

(4) A single or a plurality of materials among the contents of (2) or (3) can be used using a switcher, and the materials can be concurrently or consequently shown during the lecture.

(5) The image obtained in (1) and the materials selected in (4) and the graphic image selected in (6) are combined, thus creating a virtual lecture room and outputting the same. At this time, the presenter with a set size and the presentation content are combined with the set background and are outputted in response to the scene selection command selected by the mouse or the input switch (7). The combined screens help create a real time combined screen in a 2D or 3D real time rendering method of the multi layer method.

(6) At this time, the presenter can easily select the virtual 2D or 3D space or can create the same and decorate his own lecture room. The background image and video used for lecture, the wall with a window and 2D, 3D DB with various colors are provided, and the presenter is provided with a function of helping the presenter to create and input and an editor.

The presenter can decorate his own lecture room by editing the virtual lecture room, and change the sizes of the desk and monitor used in the lecture room, and the sizes of the lecture of the output screen seen from the virtual camera disposed in the lecture room and the sizes of the presentation screen by each scene. The virtual camera switching button editor is provided for the use of the tablet, and the image of the lecturer can be adjusted left and right with the aid of the central wheel of the left and right buttons of the mouse, and the sizes of the lecturer and the virtual screen can be also adjusted by the lecturer. The lecturer can control the apparatuses without breaking the concentration of the lecture with the mouse or the switch button while looking at the necessary scene during the lecture. Namely, the lecturer who gives presentation can adjust the size, position and ratio of the lecturer and the virtual screen with a mouse button operation, and can easily select in person the inputs of the files, namely, the content to show and the input of the notebook computer, and the camera input on the virtual screen (here, the switch buttons are formed of numeric buttons, and can be conveniently used when the mouse is not used. The switch button is designed to be easily used, so an ordinary person can learn how to use almost within 10 minutes.)

(8) The external tablet or pen input might be used for the picture drawn by the mouse to be seen in details and is designed to support the virtual electronic blackboard function which allows a marking and picture drawing on the material screen seen at the virtual screen. At this time, the virtual drawing function is designed to match with the 2D and 3D background, by means of which the marked positions are always positioned in place with respect to the size change of the virtual screen.

(9) The videos of the presentation screen combined in real time are compressed in real time and stored, and might be used for a remote lecture or a video conference by transmitting the same by way of the network or internet. So, the present invention makes possible the presentation recording, the presentation conference and the remote lecture of the presentation. The lecture effects at the remote places with the above screen can be enhanced better than the actual lecture, which leads to an actual remote presentation.

(10) The screen configured based on the inputs of (10 and 7) are displayed in real time on the large size screen.

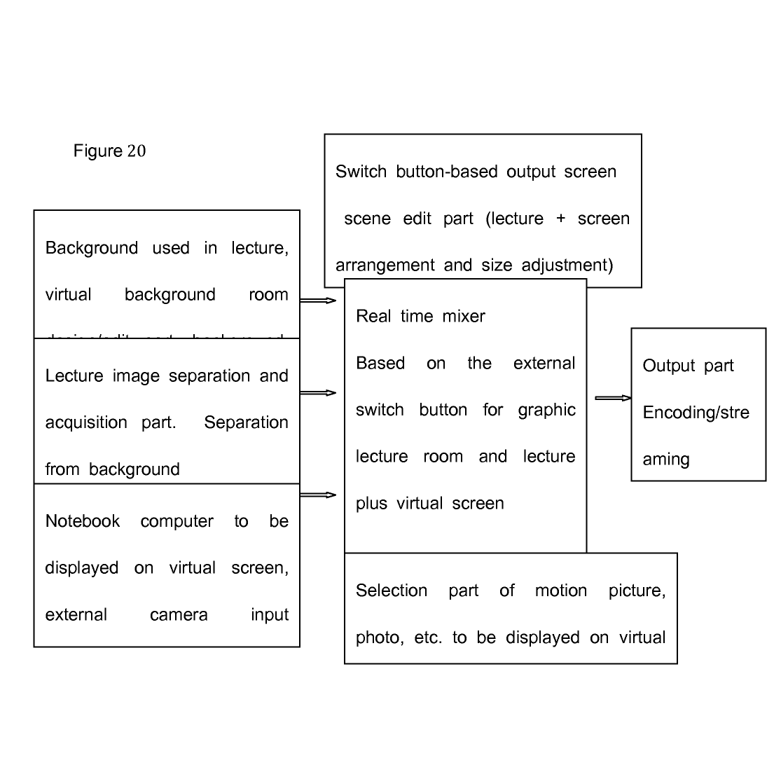

The detailed descriptions on the necessary elements needed for the operations shown in FIG. 20 is as follows.

Background and Virtual Lecture Room Design and Edition Part to be Used for Lecture

It is important to make the presentation screen more beautiful like the lecture in the broadcast station studio so as to enhance the concentration of the lecture. The editing work of the background belonging to almost scenes and the virtual lecture room studio are performed using the 3D editing program such as 3D max or Maya which are hard and complex to actually use. The studio design might be conducted by the experts. The present invention provides an editor by which a beginner can easily handle a background and interior design and decoration using the 2D multilayer or 3D template, so everyone who wants to design a studio-like lecture room can make his own lecture room.

The studio design in a 2D multilayer method: The lecture studio is overlapped on a background image and a wall and a studio screen with a window, and the lecturer and the presentation content screens are overlapped thereon in a certain size, and the switch button or mouse are set to output the above overlapped region, so the lecturer and the presentation screen are combined. The video such as a sea scene is inputted into the background, and a transparency is given at a window portion of a photo with a studio window or a scene, thus showing the background. The frame of the virtual screen is adjusted with the images, and the desk is inputted in an image form, and the sizes of the lecturer and the virtual screens are designed by the editor. Anyone who wants to create his own studio-like lecture room can define the region of the screen into an external operation switch button, and the above configuration is automatically converted in the intelligent function in the editing procedure of the studio.

3D studio design: The template is supplied to the 3D space, and the portion for inputting the background motion picture/photo outside the building the wall and window can be changed with the color or texts, thus changing with the image with a transparency such as TGA, so the presenter can change various walls and design his own styles, various colors are provided for the lecturer to select and decorate the desk in the selected colors. The size and position of the desk can be adjusted. The floor, ceiling, fence and stage can be easily changed to have different feeling, and the lecture rooms can be changed in various structures with the templates. The user can edit, and the expert in the 3D editor is provided with a tool creating his own studio.

Scene Edition Part

When a virtual lecture room is designed, the lecturer and the virtual screen are changed to the scene needed to the lecture room. The lecturer can be zoomed in along with the entire studio screen, so they all can be displayed along with the good looking studio screen. In a proper combination with the virtual screen, the editing function in terms of the presenter and the presentation content is to provide the scene with the studio, the scene that the presenter is zoomed out and the presentation content virtual screen is zoomed in, the scene seen by the virtual camera at various positions along with the function for adjusting the size of the virtual monitor and the size of the presenter. About 10 to 15 kinds of switching scenes are prepared, thus creating a scene looking smart with the motions of the mouse, and if necessary, the above scenes can be adjusted a little. The above scenes are allocated to the external switch, so the lecturer can give a lecture while pushing the button. The lecturer or lecture assistant can conveniently use the above features when recording during the lecture. The above function is very useful when controlling the position size and ratio of each object on the screen.

Real Time Lecturer Extraction Part Separating Only the Lecturer from the Background

Only the image of the lecturer is extracted from the background which is the necessary element of the present invention. For the extraction, a Chromakey technique is generally used. In this case, a green or blue actual screen is disadvantageously needed. The image comparison method of the background removal method needs a convenient, reliable algorithm. Only the presenter can be imaged and extracted by computing the distance between the presenter and the background with the aid of the recent TOF sensor. When a background image extraction is hard, the presenter is cut in an elliptical shape (Cropping), and a transparency is processed at a certain cut edge portion and is combined.

When selecting notebook computer, external camera, file type motion picture or image, they are displayed on a virtual screen for the purpose of presentation material screen.

Intelligent Real Time Mixer

The material to be outputted is in real time combined and edited with the image and virtual screen of the presenter in the previously prepared virtual space. Here, the size of the presentation screen can be automatically adjusted depending on the pointer position and its staying time of the mouse with an intelligent screen switching function. When the mouse does not move and is fixed, the image of the lecturer is zoomed in, and when the mouse starts moving, the presentation screen is zoomed in. When the mouse starts moving toward the left screen, the presenter moves right, so the presentation screen is not covered. When one scene stays for more than, for example, 10 seconds, the presentation content is switched to another scene taken at a different angle, thus allowing the audience to focus. So, the scenes are automatically switched while the lecturer gives a lecture.

Output and Subtitles

The output is formed of a video or a VGA screen and is performed in a stream type by way of the network. During the output, the recording is concurrently performed. The lecturer can give a lecture while simply operating a previously prepared subtitle screen which is displayed on the output screen in a real time subtitle form.

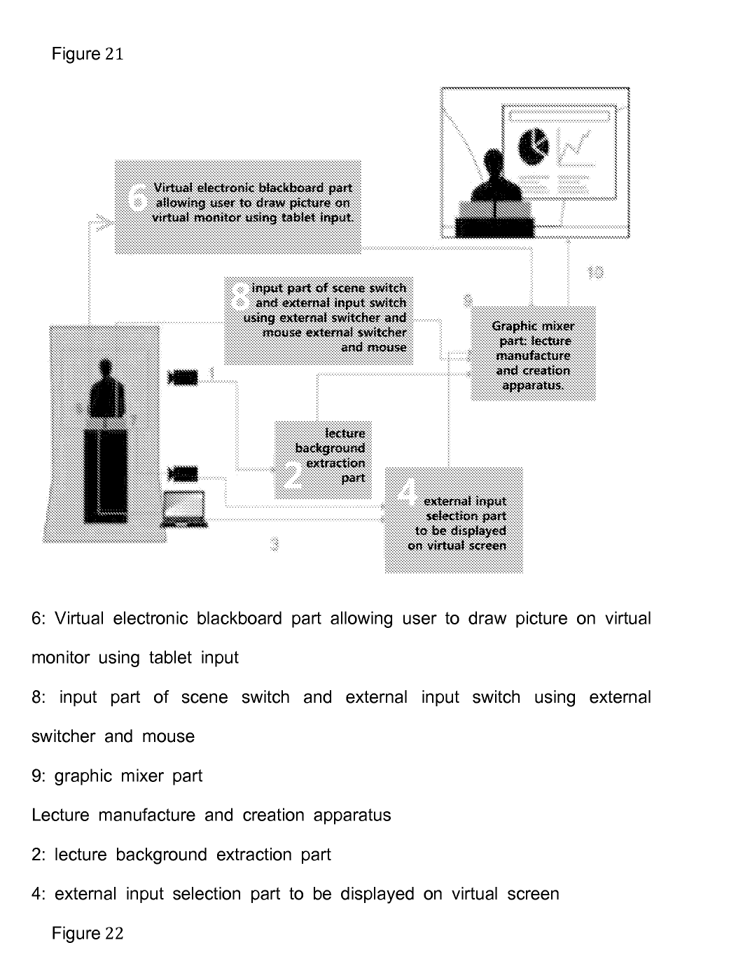

The above function will be described in more details with reference to FIG. 21.

Reference Numeral 1 of FIG. 21

In the apparatus of the present invention, only the image of the presenter taken by a single or multiple camera 1 assigned to take the image of the presenter. Here, a Chromakey method might be used to eliminate the background image except for the image of the presenter, and a TOF (Time of Flight) might be used to leave the surrounding portions of the presenter and then eliminate the pixels within the remaining distance in such a way that the images within a certain distance are adjusted to be seen with the aid of the sensor measuring the distance of each pixel.

Reference Numeral 2 of FIG. 21

The single or multiple external inputs of a notebook computer an image reading apparatus, a VTR are inputted as the camera signals in the forms of IP, VGA, HDMI, etc. The content selected by way of the input switching apparatus 4 is displayed on the virtual screen. The content can be easily selected by an external switch button or a mouse wheel 8 and click. So, the switching operation is very intuitively performed in an automatic or manual manner.

Reference Numeral 3 of FIG. 21

The apparatus of the present invention is directed to in real time combining the extracted image of the presenter, the external input content of the virtual screen with the 2D or 3D background graphics.

Reference Numeral 4 of FIG. 21

The apparatus of the present invention allows the intelligent scenes to move depending on the change of the position of the mouse as the presenter moves. In a preferred way, when the mouse stays at the leftward presentation content screen for a certain time (for example 10 seconds), the lecturer moves rightward, and when the mouse is fixed at the screen, not moving, the image of the lecturer is zoomed in, and the to virtual screen is gradually zoomed out. In another preferred way, when the scene stops for a certain time (for example, 10 to 20 seconds), the scenes are automatically switched based on the intelligent function. So, the good looking presentation videos can be produced without using an external operator in such a way that the lecturing scenes are automatically switched as long as the lecturer moves the pointer on the presentation content.

Reference Numeral 5 of FIG. 21

The apparatus of the present invention basically includes a function for freely adjusting the size, position and ratio of the presenter and the presentation material of the virtual screen by way of the simple operation of the external switch button or the mouse. Here, the output screen can be adjusted with the mouse. The lecture can give a lecture with intensive focus while looking at the output scene without a menu display because the scenes are automatically switched. All the functions can be controlled with the mouse buttons.

Reference Numeral 6 of FIG. 21

The marking, picture, writing, etc. can be inputted into the notebook computer screen, image, video, camera (image reading apparatus) etc. shown on the virtual screen with the aid of the tablet pen or the mouse. The apparatus of the present invention includes the functions of color change, thickness change and removal, and an electronic blackboard function is provided to the virtual screen during the presentation. When the screen size of the virtual screen changes, the to picture drawn on the electronic blackboard changes also in the same manner by way of the electronic blackboard function.

Reference Numeral 7 of FIG. 21

The apparatus of the present invention provides a studio editor allowing anyone to easily amend the virtual space graphics and input graphic tablet of 2D or 3D. The needed desk, wall, virtual screen frame, ceiling, bottom, etc. are previously provided and can be freely selected and changed. So, anyone can easily design a desired style of studios.

Reference Numeral 8 of FIG. 21

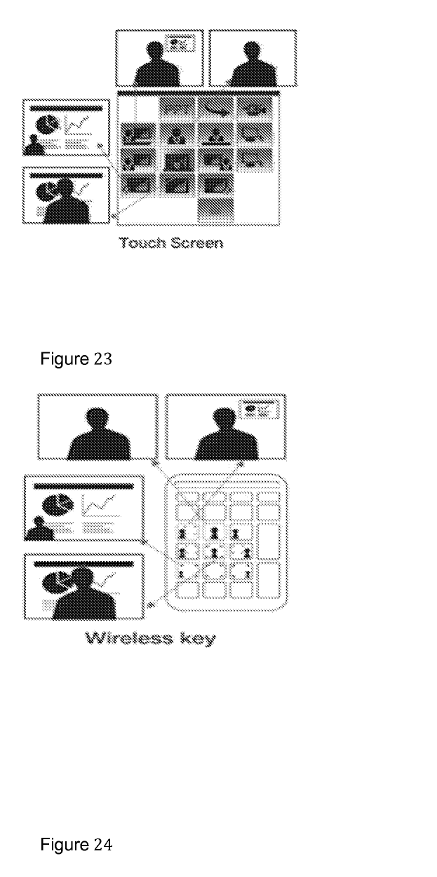

The apparatus of the present invention is directed to inputting and selecting various combined scenes and an input selection of a drawing, erasing and pen color selection of a virtual electronic blackboard the operations of which are implemented with a simple mouse click or a double click. A GUI tool is provided on the screen. The touch menu of FIG. 22 and the touch menu of FIG. 23 allow the user to intuitively control the operation with one hand using a touch menu or a simple external switch without looking at the screen. The apparatuses are intuitively designed, so a presenter can give a lecture while looking at the screen without searching for an operation button during the presentation.

Reference Numeral 9 of FIG. 21

The apparatus of the present invention can provide a lecture and a remote conference with a simple mouse control using the common notebook computer or a desktop computer in such a way that all the scene switches, drawing, erase and pen selection can be done with a mouse without using the external switch.

Screen selection: As shown in FIG. 24, the mouse is divided into a left button, a center wheel and a right button for the switching operation of the screen. The scene control is performed about the presenter. When the left moue is clicked, the presenter is positioned at the left with virtual screen on, and when the center wheel is clicked, the presenter and the virtual screen are positioned at the center, and when the right button is clicked, the presenter is positioned at the right side with the virtual screen left on. Whenever the left button is clicked, the scene is moved to the left side and when the right button is clicked, it moves to the right side. Various button changes are available.

Screen aspect ratio control: The presenter becomes a criteria, and when the screen is scrolled up, the presenter is zoomed in, and the virtual screen is relatively zoomed out, and when the screen is scrolled down, the presenter is zoomed out, and the virtual screen is relatively zoomed in. If more changes are needed, various scenes can be made. Whenever the screen is scrolled up, something is zoomed in, and vice versa, it is zoomed out.

Recording start and stop: The recording is performed with a double click of the left button of the mouse, and the recording can be stopped with a double click of the left mouse during the recording.

Slide selection of virtual screen: When the mouse is placed on the virtual screen, the scene of the screen is changed to the next to scene as the wheel of the mouse is lightly spun without clicking, and the marking used on the virtual screen is automatically deleted.

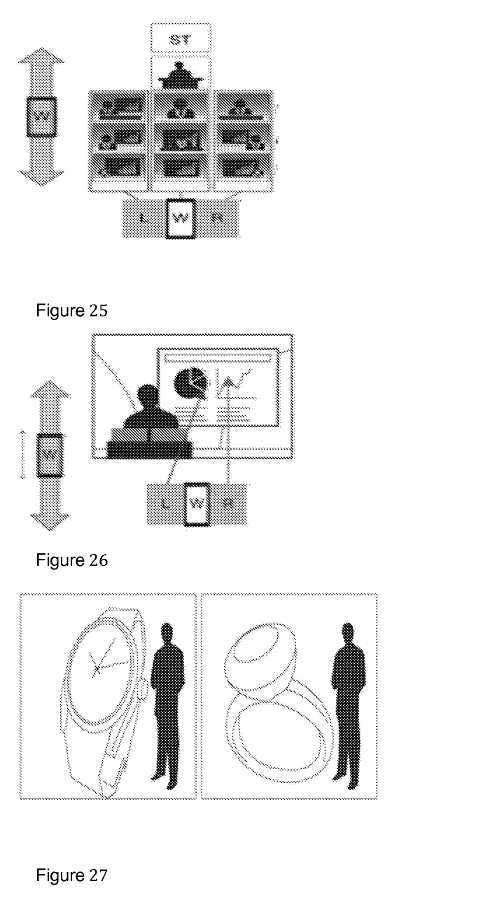

Electronic blackboard function of virtual screen: As shown in FIG. 25, when the mouse is moved with the left button keeping clicked while the mouse is placed at the screen. When the screen is scrolled, the color of the pen is changed, and when the screen is scrolled while the wheel is pushed, the thickness of the pen is changed. When the mouse is moved with the right button keeping clicked, the erase function is performed, and when the right button is double clicked, all the drawings are removed from the current screen.

Selection of input camera, notebook computer and slide of virtual screen: When the wheel is spun with the right button of the mouse being pushed, it is possible to select the external camera, notebook computer, and previously prepared media content to be displayed on the virtual screen can be selected.

The user can change or define in person the operations of the mouse button, and the operations can make functions in various forms.

The background editor and images are provided. The presentation can be displayed in various forms on multiple spaces, not in fixed screen. The presenter and presentation materials can be combined in the virtual space, so it is possible to always provide a new environment in a virtual form.

The presenter can be seen at a very close distance as compared with the conventional art in which only the fixed screen can be seen, and the screen can be intentionally zoomed in and the presenter can be zoomed out, thus making the lecture room took like a large size lecture room. The audience can maximize the concentration by providing a new presentation type as compared with a conventional presentation method with only a fixed type of screen size.

The simple multilayer mixer function is provided, and the 2D studio can be made easily by selecting the layer-based images. The video or image is inputted into the first layer, thus decorating the background, and the glass portions are decorated with the images with transparent TGA or NG information by inputting the images with walls or windows into the front layer, so the background images with the first layer can be seen by way of the windows. The layer with a virtual screen and a layer with the extracted presenter are placed at the front side, and an image layer with a desk is disposed in front of the presenter. The layer with the subtitle is last placed at the position. The user can easily create a new background before the lecture starts.

The 3D background can be designed. Since the 3D Max or Maya which are common 3D editors, are difficult to use, there are provided templates created using the above tools in the forms of various studio images which will be used for the virtual space. Here the construction of the templates can be changed anytime. The atmosphere of the virtual space can be freely changed depending on the purpose of the presentation.

The 3D templates are created depending on the criteria for the operations of the present invention, thus providing an unlimited virtual space. More templates can be created and sold. The tool to be used for creating the template can be sold.

The 3D objects are created using the 3D Max or Maya and can be seen in a virtual space as shown in FIG. 26. The interactive actions of the objects can be observed. The virtual experiment space can be formed by providing various virtual experiment manufacturing tools. The 3D object can be added or deleted, and if necessary, it can be expanded.

The videos are transmitted by way of the network, thus implementing a remote lecture and conference. Instead of using the inputs of the camera of the conventional video conference system, the outputs of the present invention can be transmitted, so the people sitting at the opposite side can see the output screen of the apparatus of the present invention, namely, the people can see the materials mixed with the presenter and the presentation materials on onscreen, so the people being at the remote place can feel like they are having a conference at the actual place which is made possible with the aid of an advanced screen.

The present invention overcomes the problems encountered in the conventional art that two screens are used in the conventional remote video conference, where the notebook computer screen is displayed on one screen, and the image of the presenter is displayed on the other screen. The present invention is directed to the remote video conference system characterized in that the scene to be displayed is selected by the presenter and is displayed on one screen. The present invention is directed to a remote video conference of the method that the image of the presenter is extracted and combined with the presentation material and is outputted as shown in FIG. 27 as compared with the conventional art in which the camera of the presenter transmits to the opponent side in person.

In the present invention, the chatting and video conference programs such as Skype, MSN, etc. can be used. The above programs are used in the apparatus of the present invention. There is provided a driver converting the output of the apparatus of the present invention into an input video of Skype or MSN, so a remote video conference can be made possible by way of the common internet. The present invention is directed to a remote video conference implemented as a common program and the present apparatus cooperates. In other words, the presentation materials are displayed on the screen of the remote area along with the image of the presenter. The scenes are switched if necessary. Various contents can be displayed on one screen. The present invention provides a new remote video conference method having an expected effect as various contents can be displayed on one screen.

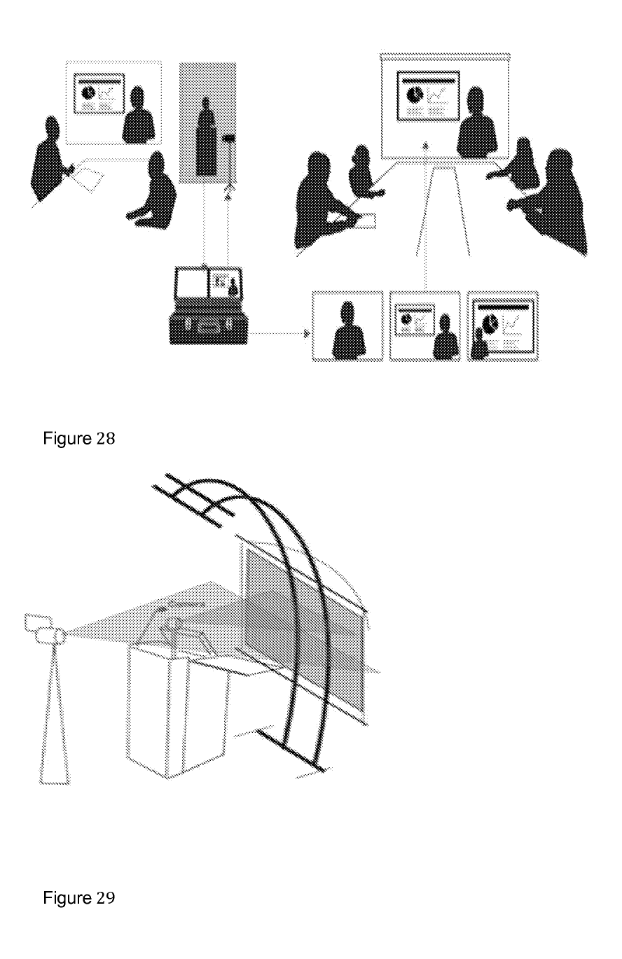

The apparatus of the present invention as shown in FIG. 28 can be inputted into the desk, thus creating an electronic virtual desk. The presentation content of the apparatus of the present invention is transmitted to the projector. Since the notebook computer, the VRT, the electronic blackboard, and the lecture recorder are all equipped in the apparatus of the present invention, a convenient virtual electronic desk can be created, which has a real time lecture recording operation. The lecture of the virtual space is possible using the VR electronic desk with a Chromakey function. The VR electronic desk according to the present invention has a background with a Chromakey effect and lightening effect, and the apparatus of the present invention is engaged in the interior of the desk. The external camera, notebook computer input, tablet, keyboard, mouse and microphone are engaged, and the output screen of the apparatus of the present invention can be displayed in the lecture desk or can be displayed in the prompter disposed at the position of the camera, so the lecturer can give a lecture while looking at the output screen. The virtual lecture desk of the present invention is formed of a real time lecture recording and remote lecture which provides the same function as the conventional electronic lecture desk such as an electronic blackboard, and an image reading apparatus.

The apparatus according to the present invention is characterized in that the presenter does not need to give a lecture while standing at the screen of the projector, but the presenter can present looking at the output screen of the apparatus of the present invention which is displayed on the front screen as shown in FIG. 29 along with the audience sitting at the rear side of the lecture room. Since the face of the presenter is displayed on the screen, the audience feels like the present stands in front of them, so the audience can give a lecture looking at one portion, not two portions. When the question and answer are needed, the presenter can perform a remote PTZ in which the image of the question person is displayed on the screen with the aid of the cameras. The presentation scenes are transmitted to the remote area, so the presentation can be seen at the remote area. The remote cameras can be activated, so the audiences in another space can hear the presentation while seeing the faces with each other, which are implemented in a remote system.

The apparatus of the present invention makes it possible to make eye contacts between the presenter and the audience. In the present invention, a prompter can be used so that the presenter can look at the camera, and the output screen can be disposed close to the camera, so the presenter can present while looking at one screen. Virtual eye contacts are always made between the audience looking at the output screen and the presenter.

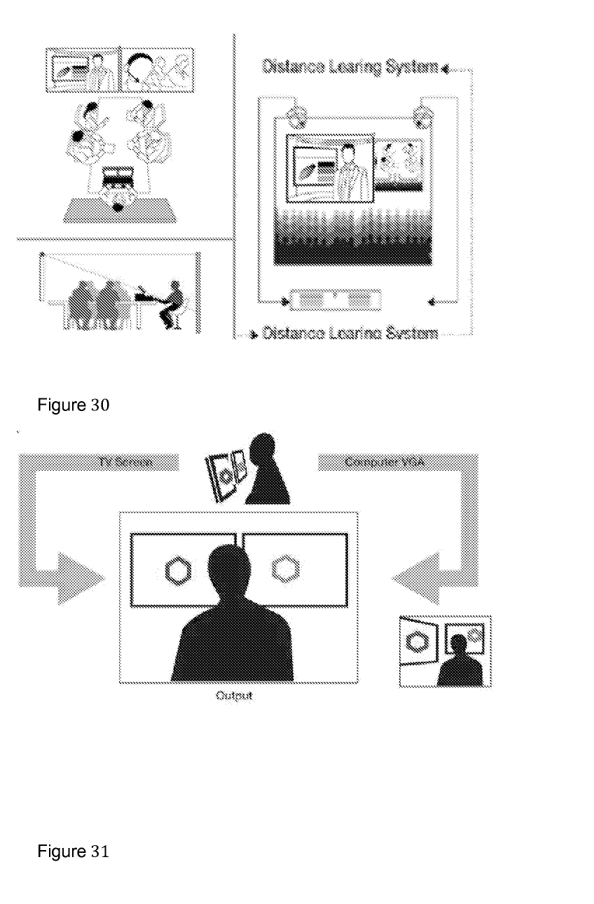

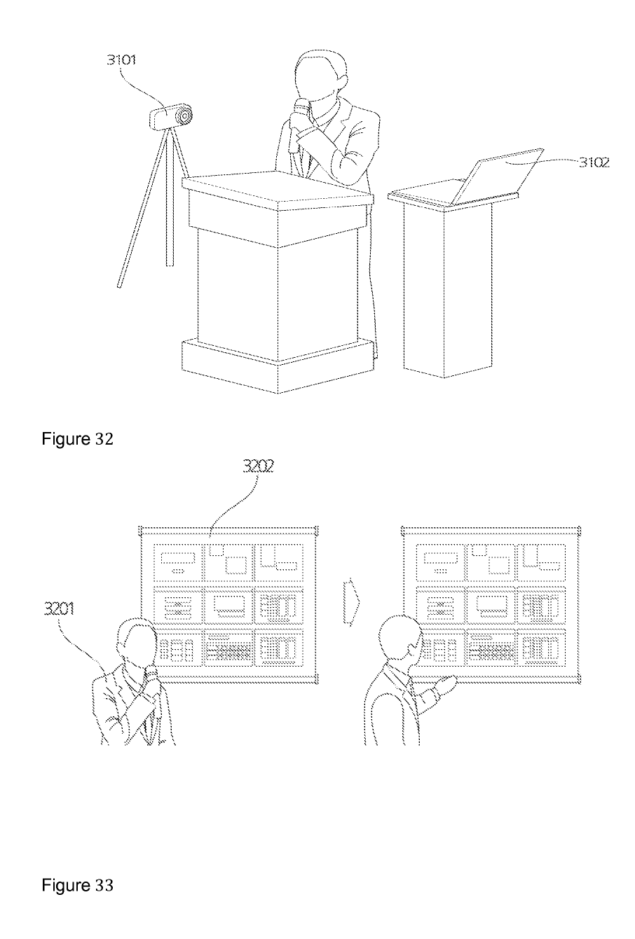

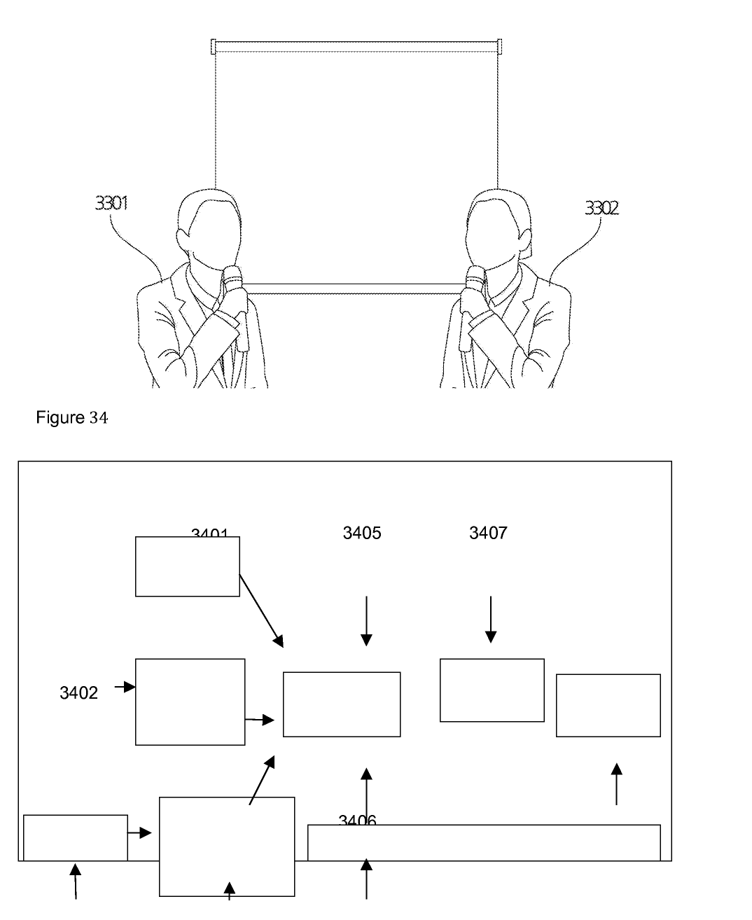

As shown in FIG. 30, a plurality of virtual screens are provided. Different materials are concurrently supplied to each virtual screen, and a virtual blackboard is provided to each virtual screen. In particular, the present invention can be well applied to when creating a manual of a product in real time. For example, the present invention might include a multiple screen template. So, when explaining the remote control operation of the television, the remote controller and the TV screen can be displayed on different virtual screens, so the TV screen changes depending on the remote controller can be concurrently displayed.

As described above, it is obvious that the present invention can be changed or modified in various forms by those who skilled in the art. The scope of the technical concept according to the present invention is defined by the following claims.

What is claimed is:

1. A virtual classroom lecture method, comprising:
(1) a step in which a plurality of 2D, 3D background layers are provided in a form of templates, and the changes of background for the same are made while changing image videos, and the graphic lecture room can be conveniently edited, and the templates are stored for the use when creating various lecture rooms;
(2) a step in which a lecturer is taken in a form of image by using a camera;
(3) a step in which the distance to the lecture is measured using a Chromakey technique or a TOF sensor from the taken image of the lecturer, and only the image of a surrounding portion of the lecturer is extracted or only the image of the lecturer is extracted by comparing the background images;
(4) a step in which a lecture material layer indicting at least one lecture material and the lecturer layer are combined and arranged at the virtual lecture room background layer, and a final image is created and outputted to a display apparatus, wherein variously combined image are edited to create a certain scene, and the created scenes are automatically or manually switched by a switch button or an automatic mouse motion detection and operation while a real time lecture is automatically or manual provided after a plurality of output scenes are set and stored;
(5) a step in which when a lecturer writes using a mouse or a tablet connected with the apparatus, and the written content is additionally combined on a virtual screen which shows a presentation material screen of the final image and is outputted to the display apparatus;
(6) a step in which the functions of a virtual integrated presentation conversion apparatus are provided in one apparatus, which functions includes a total presentation function operating an external switching conversion apparatus so as to switch and provide, on a presentation material screen, a scene streamed by way of an external camera, a notebook computer input, a USB input, a USB camera screen and IP for a lecture to variously show the lecture materials when the lecturer gives in real time lectures, and a scene showing a file, a motion picture, images, etc. including a power point data on a screen; and there is provided an electronic blackboard function for marking pictures on the scenes of the same, and an image reading apparatus function using an external camera is indicated in the virtual presentation screen, and such scene is combined with the lecturer image and the virtual lecture room and is displayed as the scenes of the virtual lecture room the operation of which is controlled by a scene switching button; and the size, position and angle of the lecture presentation material layer, the lecturer layer and the written layer are converted and recombined and are outputted to the display apparatus, and the size, position and angle of the written layer are converted at the same ratio; and the lecturer and the presentation screen are recombined using the above virtual lecture room graphic, and various scenes are automatically or manually adjusted, and there are provided a switching and mixing function for combining students, who ask questions, by way of the electronic backboard, image reading apparatus function and the external camera and a switch function switching the virtual scenes;
(7) a virtual lecture room and virtual experiment step in which an animation of a 3D graphic object is interactive adjusted using a 3D real time rendering which is impossible with a common apparatus so as to maximize a lecture effect, and the scenes are displayed with a click while moving a 3D experiment with a mouse so that various virtual experiments can be displayed in a virtual graphic lecture room, thus obtaining a virtual experiment and a virtual hands-on learning;
(8) an apparatus step in which when a combined video is outputted, the lecture images are concurrently received from both the left and right cameras, and a presentation scene is outputted, and the pictures are provided by separating into the left and right scenes, thus creating a 3D stereo virtual presentation scene, which leads to a 3D lecture;
(9) an apparatus step in which an eye contact lecture is made between the camera and the lecturer in such a way to provide a prompter to the lecturer camera and to allow the lecturer to see the output screen, and the audience looking at the output scene of the apparatus of the present invention in the above lecture room and the audience looking at a remote area can have eye contacts; and
(10) a virtual electronic lecture desk function apparatus step in which the above scenes are processed by a real time lecture recording function such as a compressing, recording, transmitting or storing function, and there are provided a remote lecture function and a video conference, a remote lecture using a virtual combined scene, and a video conference apparatus and a real time lecture recording apparatus which are provided in a lecture desk form.

2. The method of claim 1, wherein a lecturer can freely switch scenes with a left and right button of a mouse using the operation of a mouse during a lecture and a rotation of a wheel and a double click, and the marking and drawing can be made on the electronic blackboard using a mouse, and the colors and thickness are adjusted with the aid of a mouse click and the wheel rotation, and the zoom in and out of the scenes and the presentation screen and the size of the lecture and the left and right conversions can be easily performed by hands, and the lecturer can perform all the switching functions with one moue while looking at the output screen without using an additional apparatus, and the lecturer can provide a lecture with the wired or wireless mouse without using an operator of the apparatus, and all the scene selections from a recording start and stop and an external camera, a notebook computer, a motion picture-photo list can be adjusted all the functions of which are performed with a mouse switch function;
when the output screen is selected, an external simple switch is provided, and the lecturer does not need to search for a button during the lecture, and intuitively arranged buttons are provided, and it is possible to freely select a switching scene without seeing the buttons by providing an apparatus conducting the above functions, so the functions are performed by one touch;
when the output scene is selected and displayed, the automatic button is set, and the cursor of the mouse is moved to a scene of the virtual presentation screen, the scene is automatically switched to a zooming in scene, and the image of the lecturer is zoomed out in an animation form, and with the automatic switching, when a lecturer gives a lecture as the mouse moves closer to the image of the lecturer, the lecturer moves in the opposite direction during the switching, and the scene switches are automatically performed, and the pictures of the pointer are converted to an automatic scene with the function of showing a zoomed in image when the drawing and marking are performed, and when there is no mouse motion, and the fixed time is not presented, the image of the lecture is automatically zoomed in, and the virtual presentation scene is zoomed out based on the animation change or switching screen by providing an automatic switching function, so the lecture can be performed with the scenes being automatically switched without using apparatuses, whereby the automatic lecture combinations are possible; and
when in a step, the automatic screen conversion button of the screen construction conversion apparatus is on, as the set time of one scene passes, the size, position and angle of the lecture material, the lecturer layer and the written layer are converted and recombined, and the switching of the selected scene is automatically outputted to the display apparatus, and the size, the position or the angle of the lecture material layer and the written layer are converted at the same ratio.

3. A virtual lecture room lecture apparatus, comprising:
said apparatus being performed with the aid of a function in which an image of an audience, who is questioning, is displayed on a virtual presentation screen or the scenes are switched, using at least one camera taking the image of a lecturer and an external camera showing an audience and a real thing, a document camera function in which a picture or an object is in real time displayed on the virtual presentation screen by way of the camera like a simple USB camera, and a function in which an electronic blackboard function is implemented on the virtual screen for a drawing and marking on the virtual presentation screen with the aid of an input apparatus showing an external computer screen on the virtual screen like a notebook computer and an input apparatus for drawing a picture or letter like a tablet, and an apparatus providing a motion in response to an external command is connected by way of a joystick, and the virtual object of the real time graphic can be adjusted; and
said virtual lecture room lecture apparatus, comprising:
a background eliminating apparatus which uses a Chromakey technique or a TOF sensor for extracting only an image of a lecturer as a lecturer layer by systematically eliminating the background components form the lecture image that the camera has taken;
an apparatus in which the previously background layer and the lecture material layer are combined, and the virtual lecture room image is converted to a 2D or 3D real time rendering screen, and the lecturer layer obtained by using the Chromakey apparatus and the written layer written using the tablet by the lecturer are combined with the virtual screen image, thus creating a final image, and the scenes of various screen constructions are in real time handled automatically or manually, thus simplifying all the operations;
an apparatus in which the size, position and angle of the lecture material layer, the lecturer layer and the written layer combined with the final image are controlled, thus automatically or manually performing the screen construction conversion which leads to a change of the construction of the final image; and
a 3D stereo apparatus which outputs the final image created by the layer combination apparatus; and
said layer combination apparatus, comprising:
a database part which stores the data needed for virtual lecture room changes such as various pictures and motion pictures and lecture desk for the background layer and the virtual lecture room interior, and the materials needed for setting, and the materials needed for the real time lecture;
a virtual lecture creation part which combines the lecture materials and the background-removed lecturer with the 2D, 3D background layer in a layer combination method, thus creating the image of the virtual lecture room scene;
a rendering part which combines the written layer from the tablet with the virtual presentation screen displayed on the virtual lecture room, thus creating the final image and outputting to the display apparatus; and
a screen conversion part which changes and recombines the size, position and angle of the lecture material layer by the rendering part, the lecturer layer extracted from the background, and the written layer.

4. The apparatus of claim 3, further comprising a microphone receiving a voice of a lecturer, by which it is possible to use a real time lecture recording apparatus which records the final combination image to outputted by way of the display apparatus in a lecture file form, and an apparatus for transmitting the data and receiving the opponent's screen, thus performing a bidirectional video conference.

5. The apparatus of claim 3, wherein said apparatus provides an electronic lecture desk of a virtual studio type having a background of a background Chromakey with a lecture desk equipped, and a simple lighting, thus implementing an integrated electronic blackboard, image reading apparatus and virtual experiment.

6. The apparatus of claim 3, wherein a lecture room is configured in such a way that the final image is transmitted to the center server connected by way of the internet or the network by compressing the output screen of the rendering art, and the server transmits the lecture video to a plurality of lecture rooms of the remote area, and the cameras and microphone videos of each remote lecture room display in each lecture room, and the audiences in the lecture rooms can ask question or answer to questions while looking at the large screens with the virtual lecture scenes.
